(19) United States
(12) Patent Application Publication
(10) Pub. No.: US 2006/0105375 A1
(43) Pub. Date: May 18, 2006

(54) Bioretrosynthetic methods for preparing products and compositions related thereto

(76) Inventor: Brian O. Bachmann, Nashville, TN (US)

Correspondence Address: NEEDLE & ROSENBERG, P.C., SUITE 1000, 999 PEACHTREE STREET, ATLANTA, GA, 30309-3915, US

(21) Appl. No.: 11/274,741

(22) Filed: Nov. 15, 2005

Related U.S. Application Data
(60) Provisional application No. 60/628,445, filed on Nov. 16, 2004.

(51) Int. Cl. C40B 40/08; C40B 40/10

(52) U.S. Cl. 435/6; 435/7.1

(57) ABSTRACT

Disclosed herein are methods of producing molecules in a natural system and methods for identifying metabolic pathways. Also, disclosed herein are methods and compositions for constructing biosynthetic pathways in whole cells and cell-extracts to produce molecules of interest.

### I. CROSS REFERENCE TO RELATED APPLICATIONS

This application claims the benefit of priority to U.S. Provisional Application 60/628,445, filed Nov. 16, 2004. US Provisional application 60/628,445 is incorporated herein by this reference in its entirety.

### II. FIELD

Disclosed herein are methods and compositions for constructing biosynthetic pathways in whole cells and cell-extracts to produce molecules of interest.

### III. BACKGROUND

A primary goal of many chemists is the synthesis of molecules, and chemists around the world have devoted a great deal of time to preparing both old and new molecules. Many of these molecules are complex natural and non-natural products, clinically important therapeutics, or other molecules that have some interest to the researcher. Some common examples of molecules synthesized by chemists included pharmaceuticals, polymers, pesticides, herbicides, microbicides, dyestuffs, food additives, perfumes, coatings, adhesives, cosmetics, and detergents, to name but a few.

One approach typically taken when developing ways to prepare such molecules is termed “retrosynthesis.” With this approach, the researcher begins by considering the structure and properties of the target molecule. Then, based on an understanding of various chemical transformations, the researcher identifies a precursor(s) of the target molecule that, upon a given chemical transformation, will yield the target molecule. The precursor(s) identified by this method can then become the starting point for another retrosynthetic step. That is, the researcher can identify a precursor(s) for the precursor(s) used in the subsequent step. Oftentimes, this process is repeated until the researcher ultimately finds a suitable starting material(s) from which to begin the synthesis of the target product. Such retrosynthetic approaches are also known as “disconnection approaches.” For a review of retrosynthesis in the context of organic chemistry see Warren, S., Organic Synthesis: The Disconnection Approach, John Wiley & Sons, N.Y. 1996.

Such retrosynthetic approaches have been used to synthesize extremely complex molecules such as, prostaglandins, rapamycin, taxol, brevetoxin, ginkgolide B, and the like (see Nicolaou, K. C. and Sorensen, E. J., Classics in Total Synthesis, VCH, N.Y. 1996). However, a shortcoming of using retrosynthesis to develop a synthetic strategy towards a target molecule is that many if not all of the steps of the synthesis are performed in the laboratory and thus have certain undesirable characteristics. For example, some steps may require complex or expensive reagents, some steps may require drastic or extreme conditions, some steps may result in low yield, some steps may have poor enantiomeric or diastereomeric selectivity, some steps may have poor regioselectivity, or some steps may result in side or by-products, requiring purification. Furthermore, yield may be low. To minimize these and other undesirable characteristics of a synthesis, an initial retrosynthetic scheme is often revisited, changed, and optimized. Ultimately, the development of a suitable synthetic strategy towards a molecule of interest can take many years. And for some molecules, a suitable laboratory synthesis may never be developed based on these techniques.

In contrast to a wet lab approach, an approach using modern organic chemical synthesis techniques, man's approach to molecule synthesis, nature's approach can be much more efficient, avoiding the problems of traditional laboratory techniques. Natural systems (e.g., cells of plants, animals, bacteria, etc), are known to produce enantiomerically or diastereomerically pure complex molecules in good yields and in a relatively short period of time. In fact, the survival of these systems can be dependant on their ability to successfully synthesize complex molecules, which can be required for such cell functions as growth regulation, replication, signaling, motility, and defense. Indeed, many of the most sought after molecules by synthetic chemists are molecules made naturally by some type of organism.

In most cases, nature produces these natural products in vivo via a multistep chemical synthesis, termed a biosynthetic pathway, which transforms starting materials of primary metabolites (amino acids, sugars, acetate, etc.) into structurally complex molecules. Transformations along the biosynthetic pathway are generally catalyzed by enzymes, which in turn typically are coded for by single genes. In bacteria, genes for a given biosynthetic pathway are typically clustered, while in plants, genes can be interspersed throughout the plant genome. Biosynthetic studies have revealed and characterized numerous natural product biosynthetic pathways of varying complexity.

Given nature's success in preparing complex molecules, attempts to use natural enzymes to perform chemical transformations in laboratory or industrial settings have been the topic of much research. Many of these attempts, however, have met with complications because natural enzymes are oftentimes not well suited to laboratory or industrial applications. Common difficulties include poor substrate solubility, breakdown of unstable products, or competing chemical reactions. Also, the conditions for various enzyme reactions may be unsuitable for large-scale productions.

In nature, the solution for such problems revolves around natural selection and evolution. That is, biosynthetic pathways evolve over time depending on the selective pressure being placed on them at a given time. During this evolutionary process, the enzymes responsible for various chemical transformations along the biosynthetic pathway are altered, resulting in varying degrees of substrate specificity and efficiency. By mutation and selection, natural enzymes are optimized to be highly specialized for specific biological functions within the context of a living organism. Laboratory or industrial settings, on the other hand, usually require enzymes which are stable and active for long periods of time, active in non-aqueous solvents, and enzymes that can accept different substrates (e.g., non-natural substrates).

One strategy researchers have tried in order to find enzymes that can overcome these problems is called “directed evolution” (see U.S. Pat. No. 5,512,463 to Stemmer and U.S. Pat. No. 6,326,204 to DelCardayre). In directed evolution new enzymes are produced in recombinant organisms by altering their amino acid sequence and therefore enzyme properties through modifications at the DNA and protein levels. The first step generally involves creating genetic diversity surrounding a target enzyme, for example, mutagenesis and/or recombination of one or more parent sequences, producing a set of variant genes. This set can be cloned back into a plasmid for expression in a suitable host or organism. Clones expressing improved enzymes are identified, usually in a high-throughput screen, or in some cases by selection, and the gene(s) encoding those improved enzymes are isolated and recycled to the next round of directed evolution. Directed evolution has been successful at improving enzyme function in non-natural environments, improving enzyme activity towards a new substrate, tuning region or stereospecificity, or increasing functional expression in a heterologous host.

Disclosed herein is a combination of these two worlds: (1.) the synthetic retrosynthetic approach to molecule production and (2.) nature's biosynthetic approach to synthesizing molecules. Accordingly, the methods and compositions disclosed herein allow production of any molecule from any starting material in a natural system, even if the molecule has never been made in a natural system.

### IV. SUMMARY

In accordance with the purposes of the disclosed materials, compositions, articles, devices, and methods, as embodied and broadly described herein, the disclosed subject matter, in one aspect, relates to methods of producing molecules in a natural system and methods for identifying metabolic pathways.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### V. BRIEF DESCRIPTION OF THE FIGS.

The accompanying figures, which are incorporated in and constitute a part of this specification, illustrate several aspects described below.

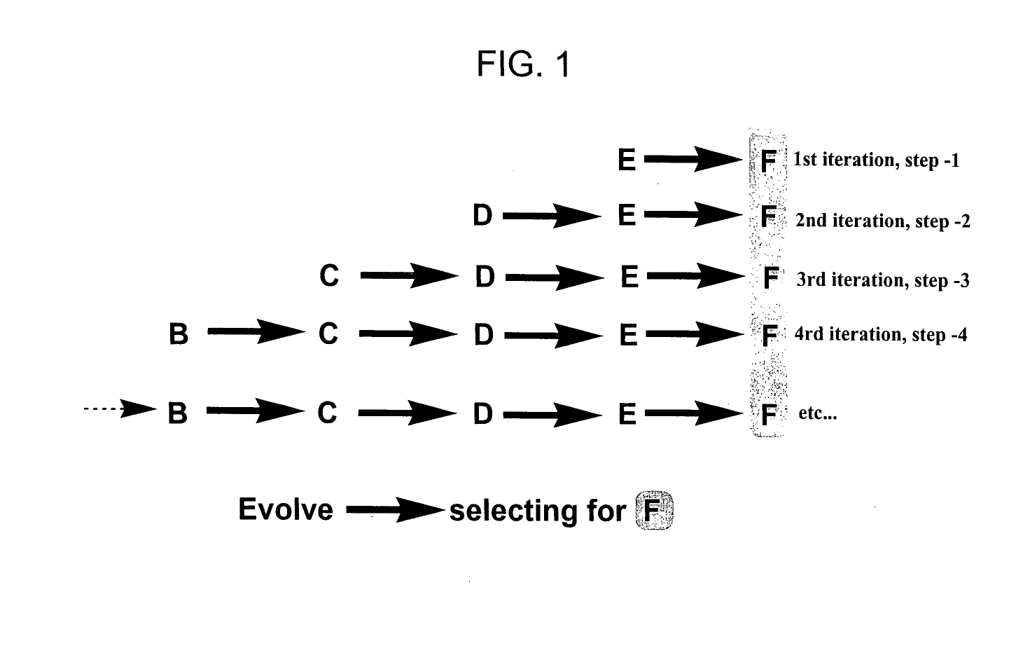

FIG. 1 is a representation of a bioretrosynthesis process according to the methods disclosed herein. Screening for the last step in the transformation (E to F) or product F drives the evolution of a multistep pathway leading to F.

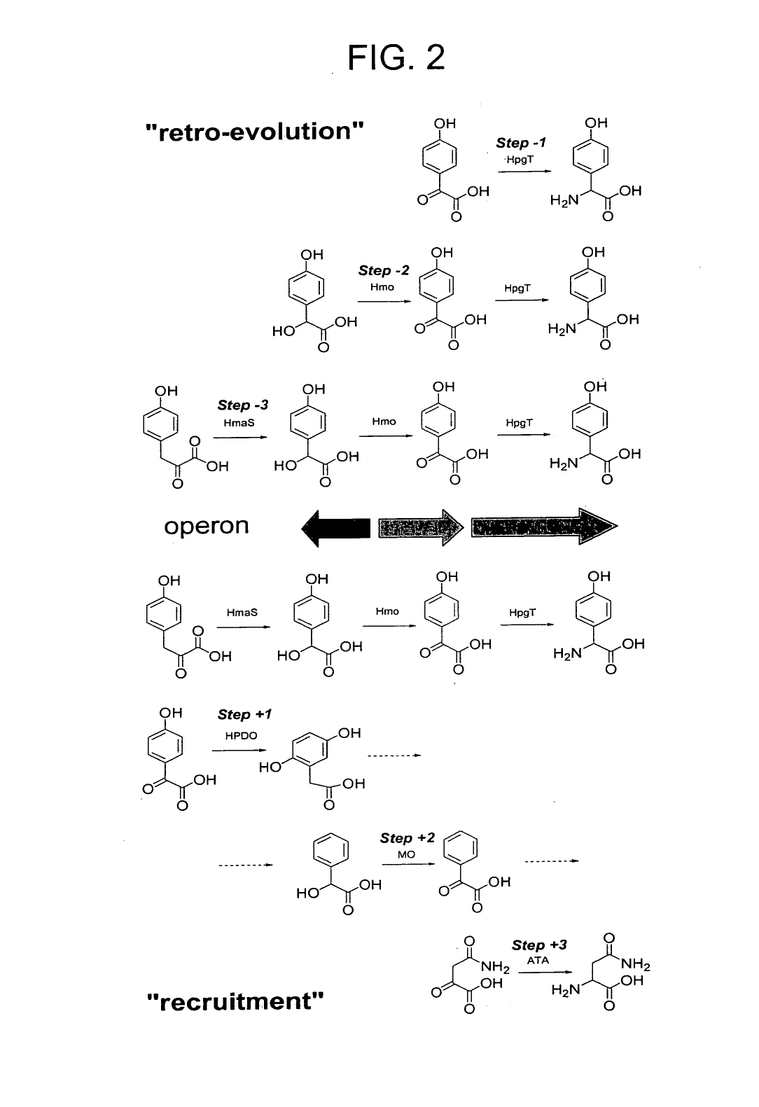

FIG. 2 is a schematic showing the two theories of biosynthetic pathway evolution, retro-evolution and recruitment, applied to L-p-hydroxyphenylglycine, a component of vancomycin type antibiotics.

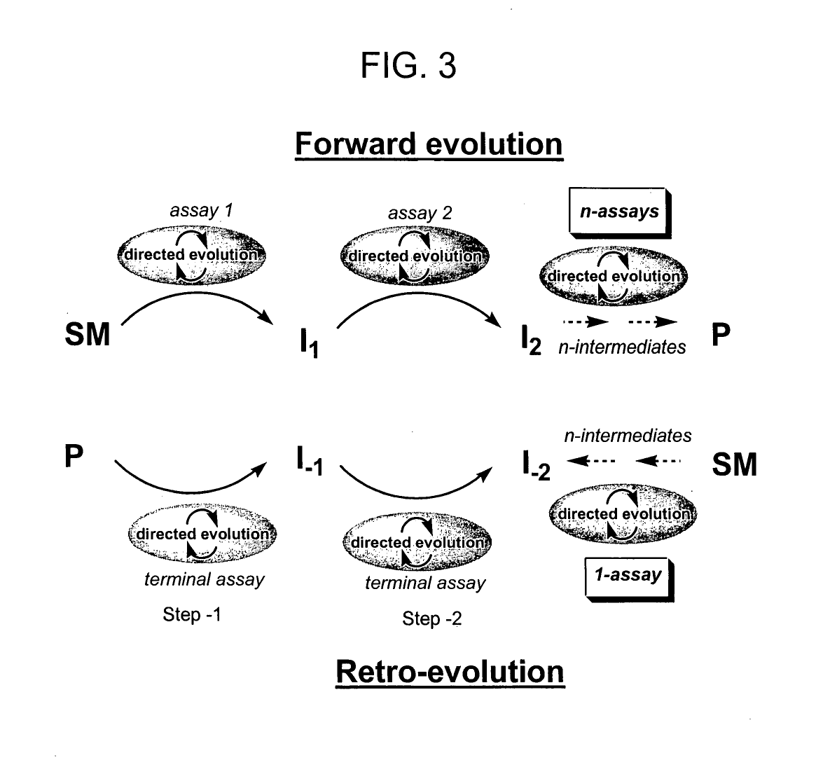

FIG. 3 is a diagram showing two models for laboratory biosynthetic pathway concatenation.

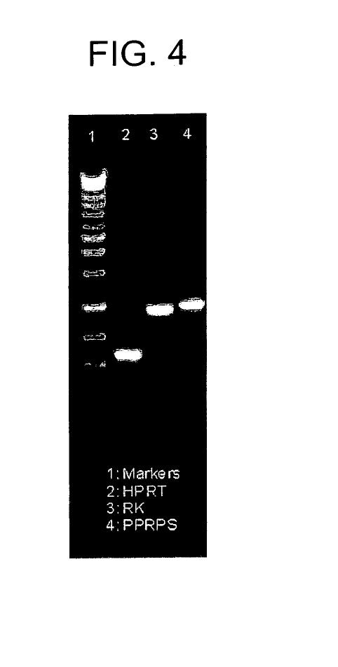

FIG. 4 is a photograph of a gel from PCR of HPRT, PPRPS. RK.

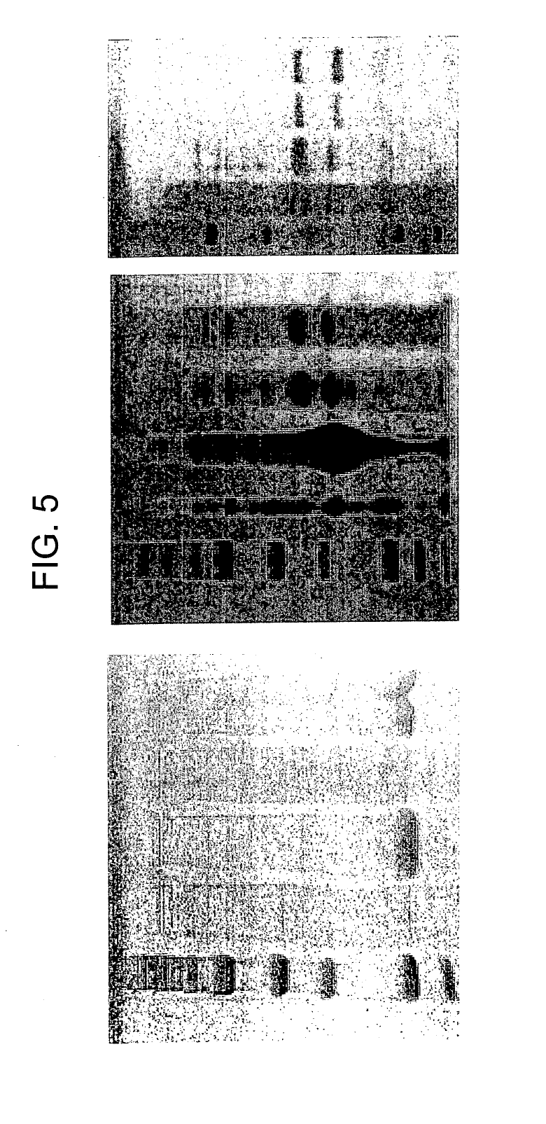

FIG. 5 is a series of photographs of SDS-PAGE gels showing overexpression of HPRT (left panel) and PPRPS (middle panel). From left to right, lane 1: markers, lane 2: insoluble uninduced, lane 3: insoluble induced, lane 4: soluble uninduced, lane 5: soluble induced. Right panel shows nickel affinity chromatography fractions of PPRPS cell-free extract from pET28-PPRPS cell-free extract. PRPPS is the lower band in the last column.

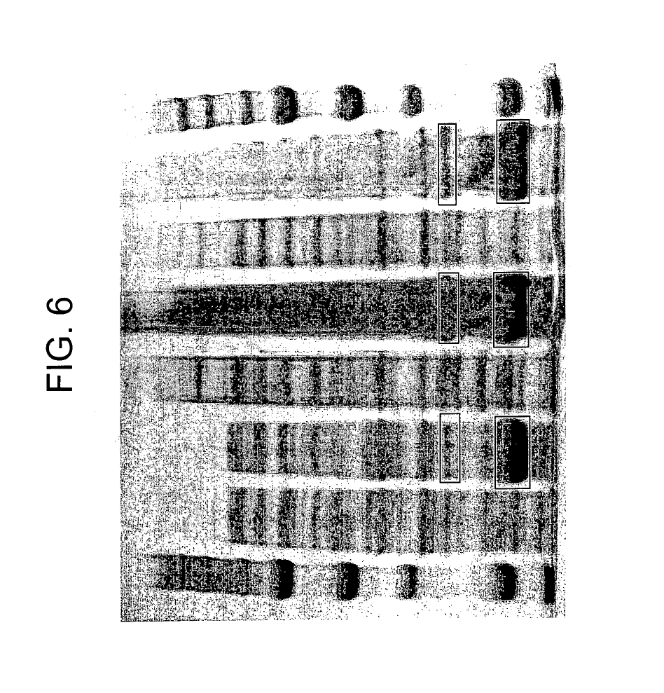

FIG. 6 is a photograph of a SDS-PAGE gel of co-expressed HPRT (lower band) and PPRPS (upper band) co-overexpression in pET28-HPRT/pACYC-PPRPS cotransformant. From left to right, lane 1: marker, lane 2: soluble uninduced, lane 3: soluble, induced, lane 4: insoluble uninduced, lane 5: insoluble induce, lane 6: total protein uninduced, lane 7: total protein, induced, lane 8: marker.

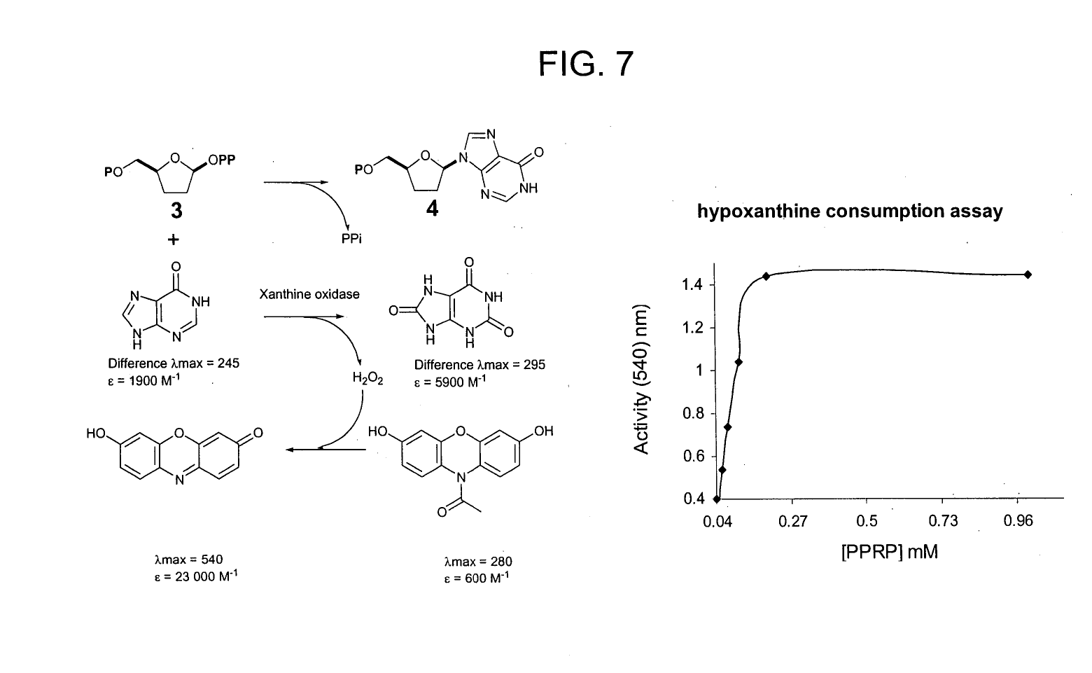

FIG. 7 is a scheme and a graph showing the coupled colorimetric detection scheme for HPRT activity (left panel) and application (right panel) with overexpressed HPRT and varying PPRP concentrations. Assay was performed in UV transparent 96-well plates in a SPECTRAMAX 384-well plate reader with path-length correction (PATHCHECK™) to compensate for slight differences in well volumes.

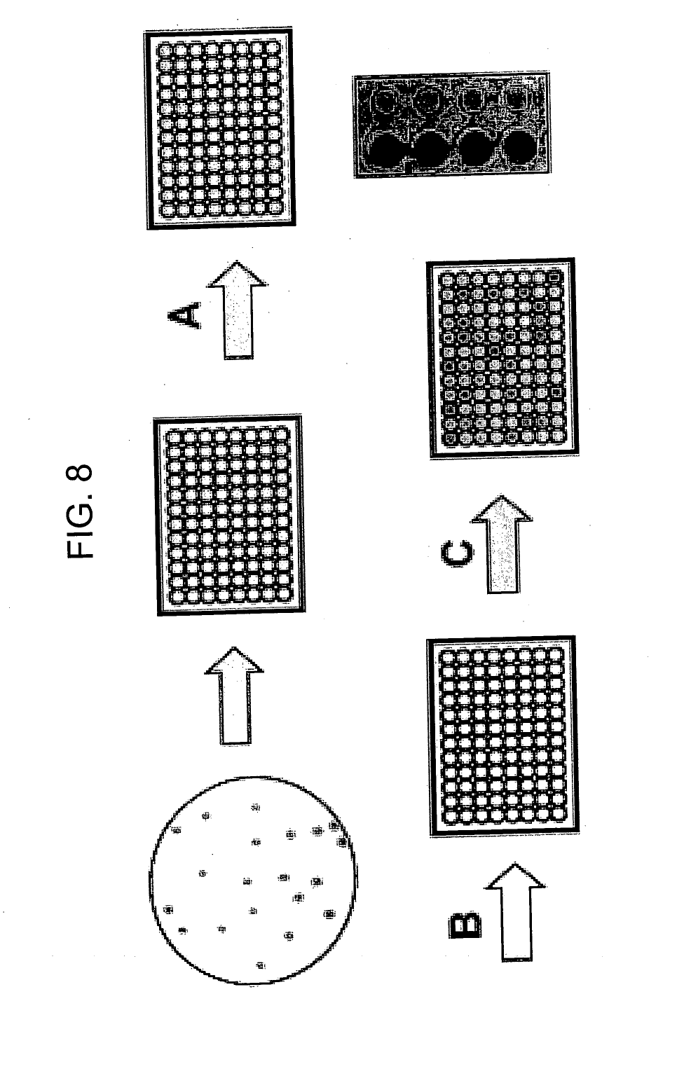

FIG. 8 is a diagram showing a 96-well screening method based on hypoxanthine consumption assay. Mutant colonies containing pET28-HPRT plasmids were picked into deep 96-well plates containing 200 μL media and incubated overnight. A: 50 μL overnight culture was inoculated into 150 μL LB containing 1 mM IPTG and incubated for 3 hours. Cells were disrupted with 22 μL of 10× BugBuster reagent. B: 10 μL of cell-free extract was aliquoted to a clean UV transparent microtiter plate. C: 100 μM Hx, 1 mM ddPPRP, 12 mM MgCl₂, 100 mM Tris HCl were added to a final volume of 100 μL, and incubated for 30 minutes at 25° C. The bottom right inset shows the results of this assay for eight transformants. In the first column are four pET28 transformants (empty vector) and in the second column are four pET28a-HPRT transformants.

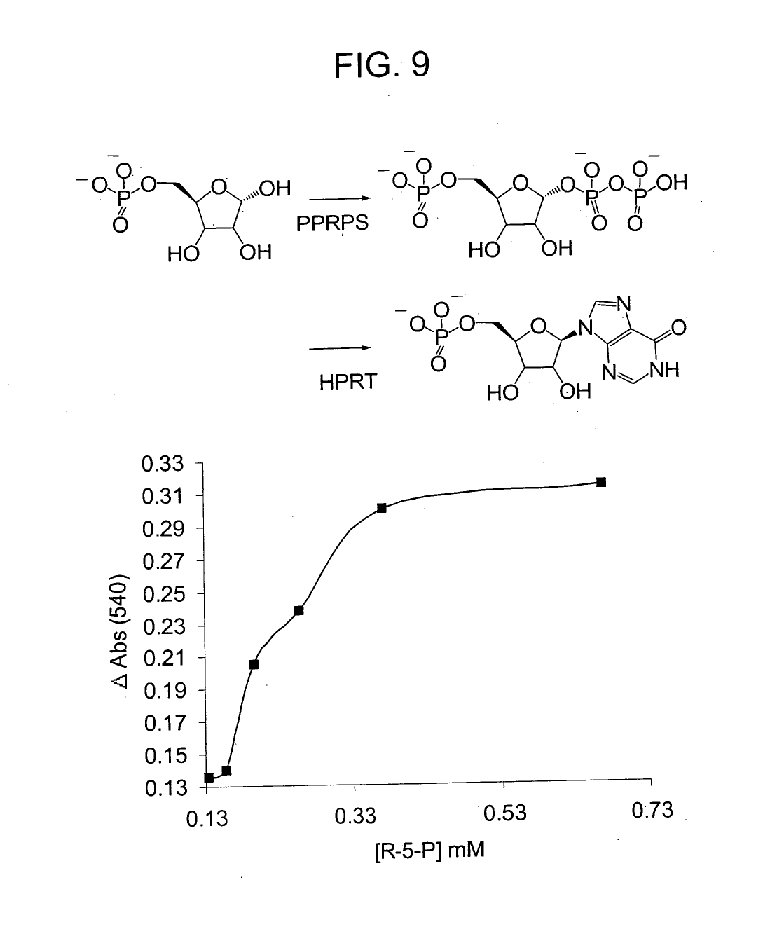

FIG. 9 is a scheme and a graph showing a tandem conversion of ribose-5-phosphate to IMP by cell free extracts from the pET28-HPRT/pACYC-PPRPS co-transformants.

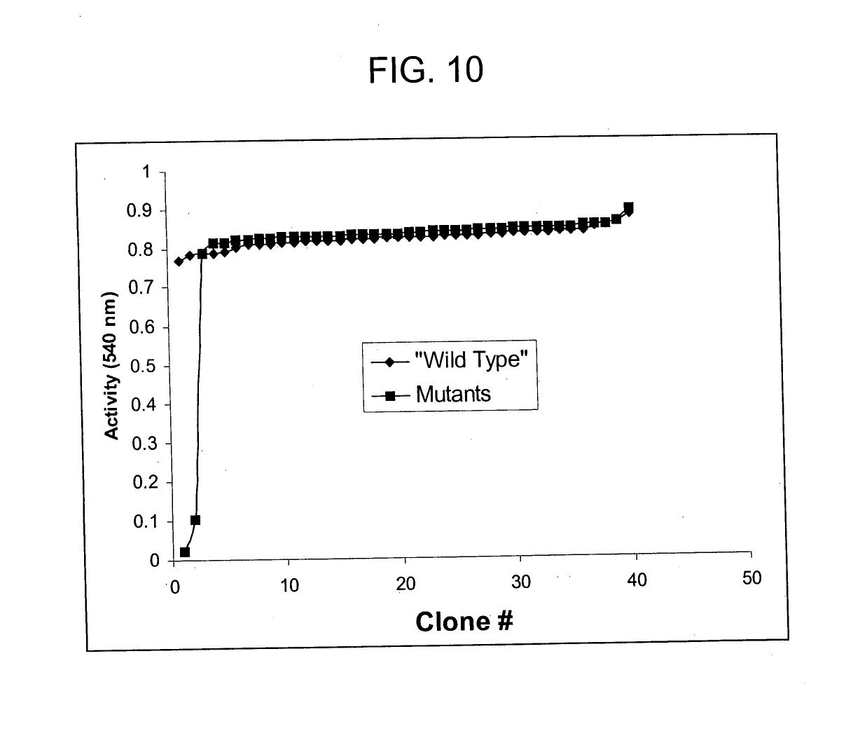

FIG. 10 is a histogram of 40 clones containing mutant variant of HPRT.

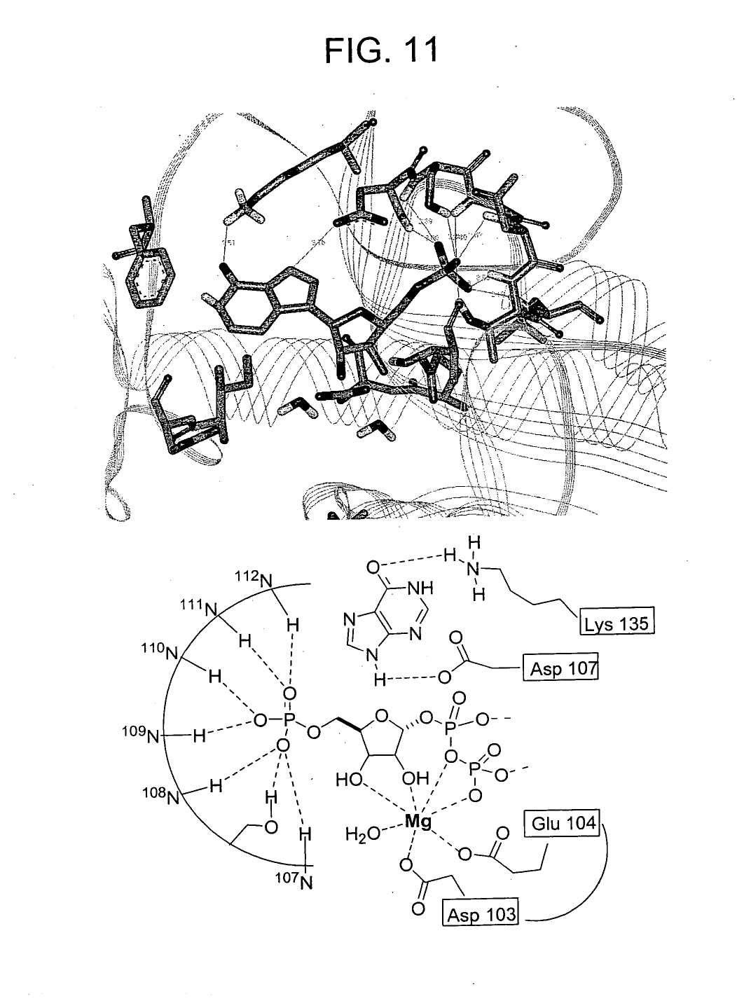

FIG. 11 (top panel) is a diagram showing E. coli HPRT structure (1G9S) with IMP bound. In this structure pyrophosphate has departed the active site with bound magnesium. Hypothetical active site geometry of HPRT based on apo structure (1GRV) and IMP structure (top), which shows magnesium coordinated by aspartate and glutamate (bottom panel).

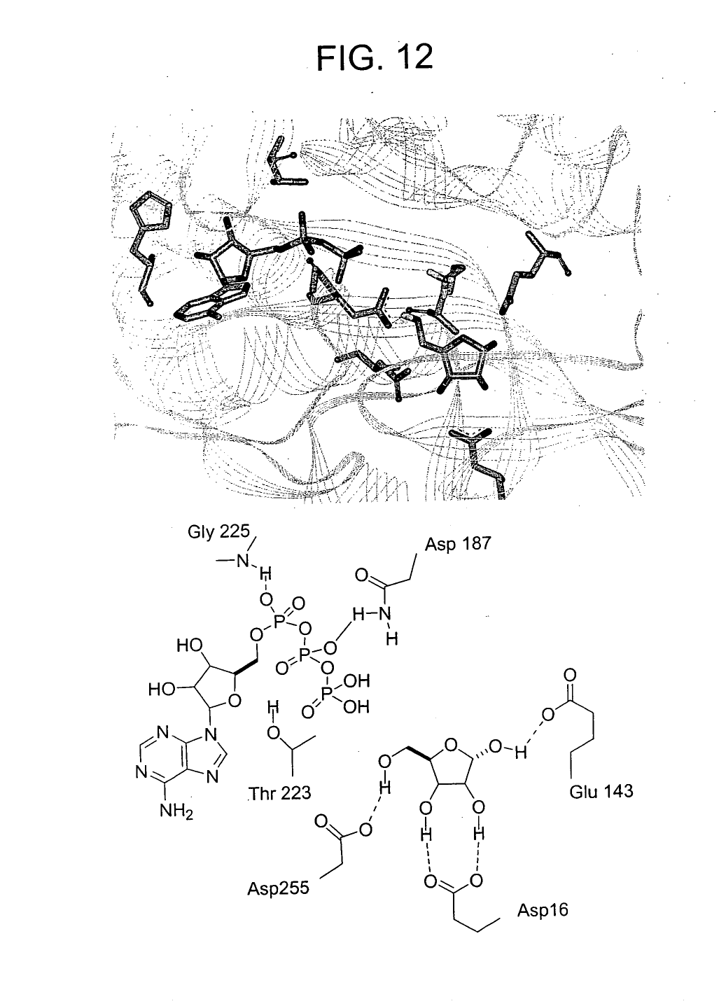

FIG. 12 (top panel) is a diagram showing E. coli ribokinase structure (1RK2) with ADP and ribose bound. Residues hypothesized to be involved in interactions with ATP and ribose are shown on the bottom. An interaction that will be lost with the non-natural substrate dideoxyinosine is that of Asp16 with the 2′ and 3′ hydroxyls.

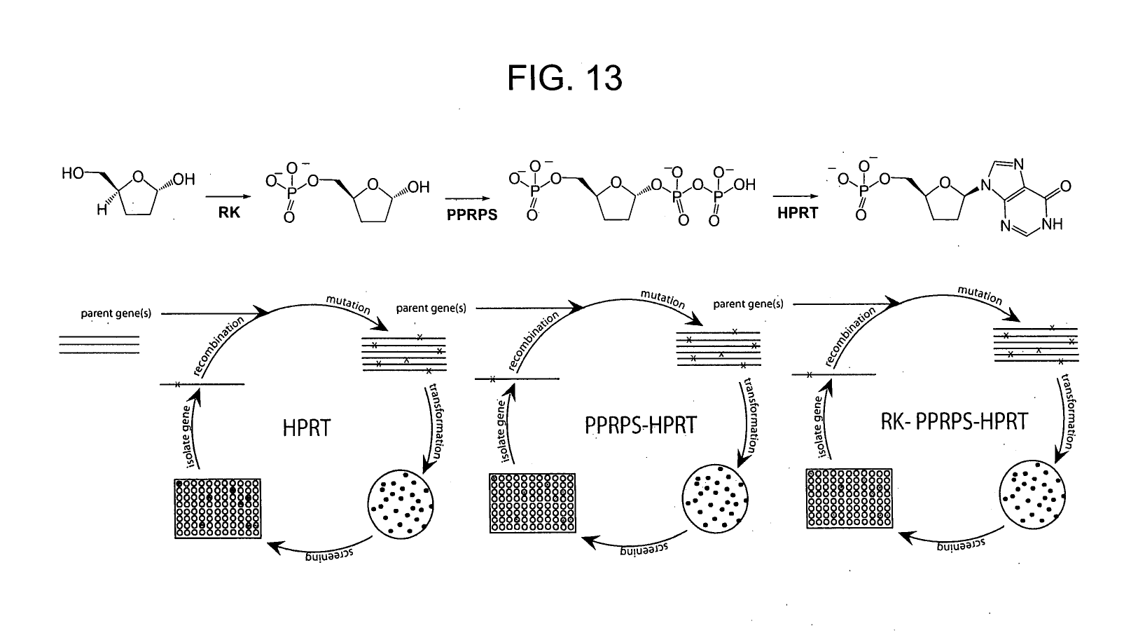

FIG. 13 is a retro-evolutionary scheme.

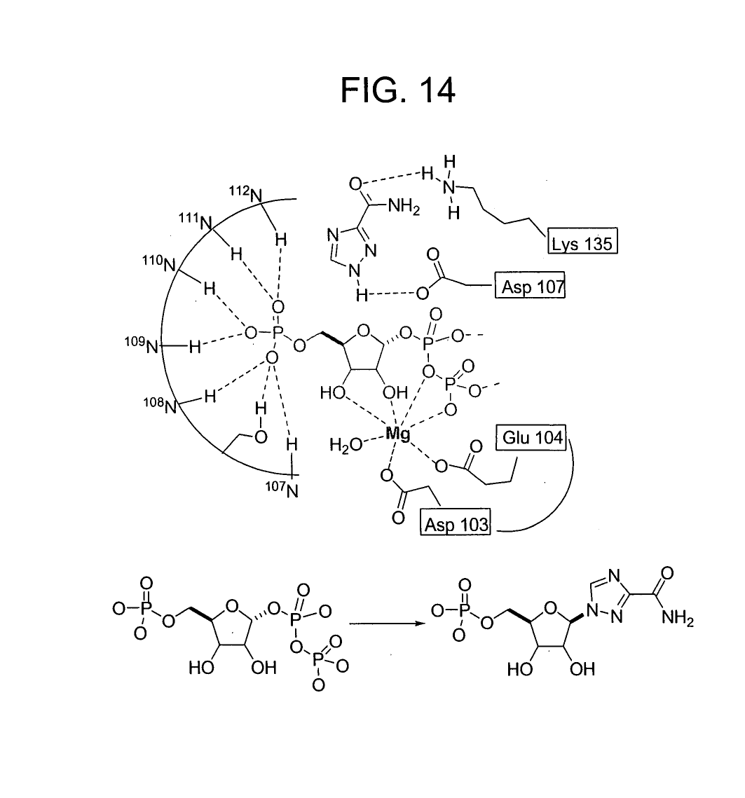

FIG. 14 is a diagram showing the hypothetical binding interactions for ribavirin monophosphate synthase.

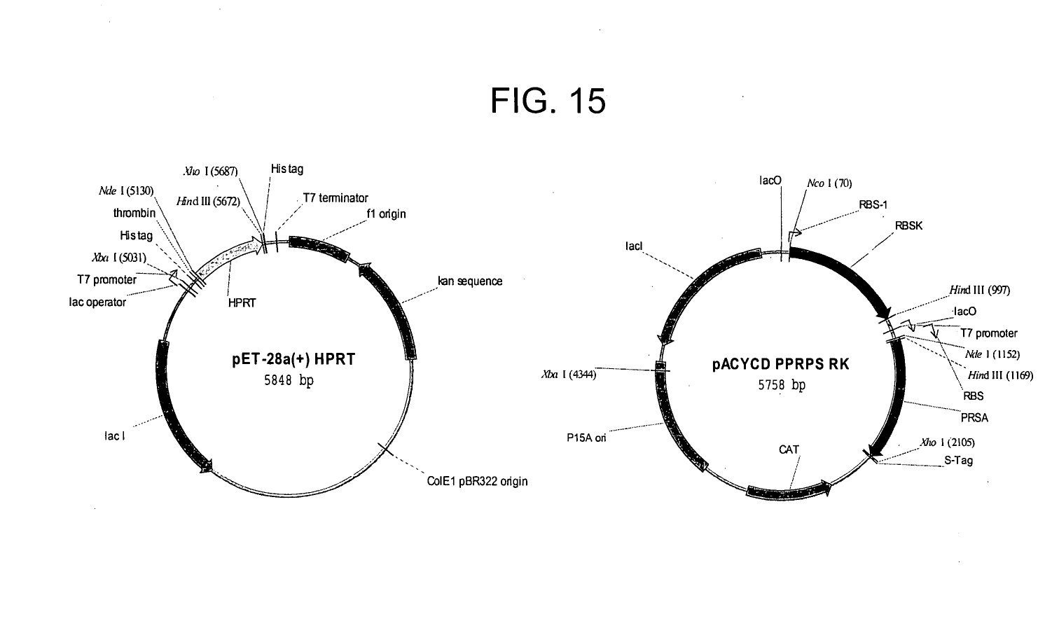

FIG. 15 is a diagram showing the multiplasmid expression system for dideoxyinosine pathway. HPRT is expressed from a pET28a construct and PPRPS and RK are expressed from the dual expression vector pACYCD. These two vectors have distinct antibiotic resistant markers and replicons and are therefore compatible within the same host.

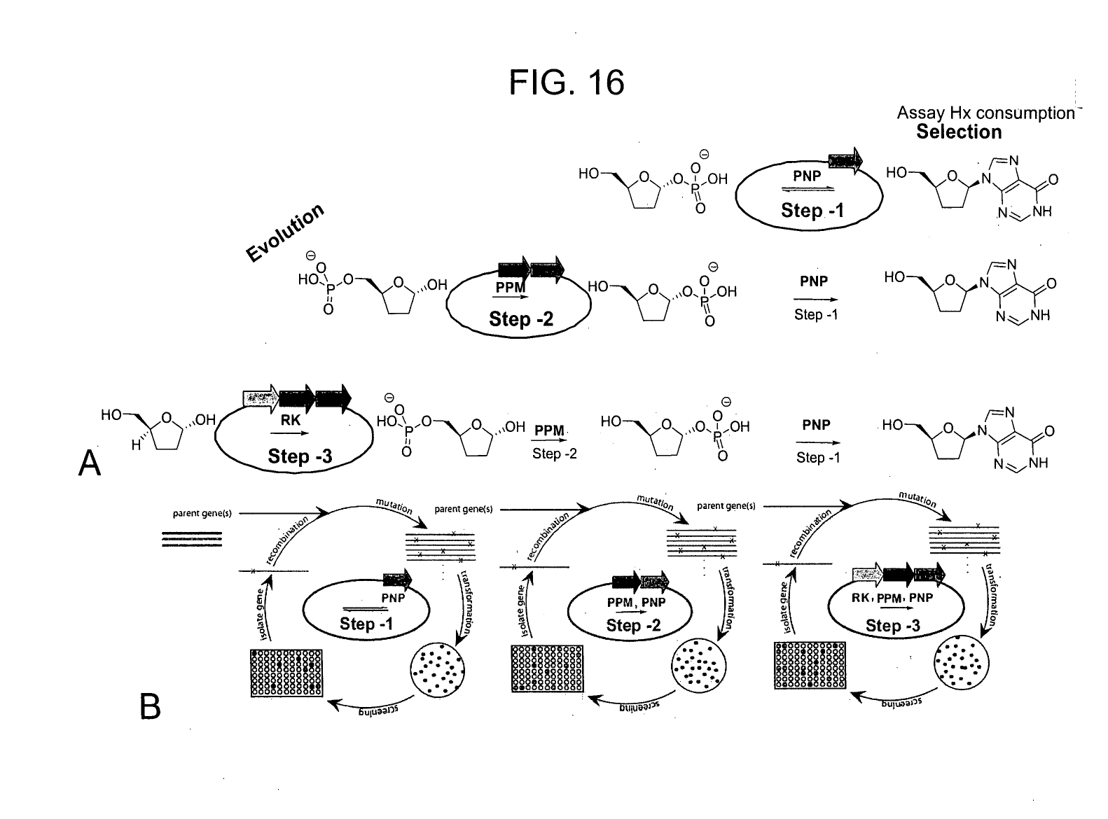

FIGS. 16A and B are a schemes showing a bioretrosynthetic pathway for dideoxyinosine. PNP (purine nucleoside phosphorylase), PPM (phosphopentomutase), and RK (ribokinase) are evolved retroconsecutively, selecting for product ddI. Selection criteria are transmitted from product to early biosynthetic steps through optimized intermediate steps.

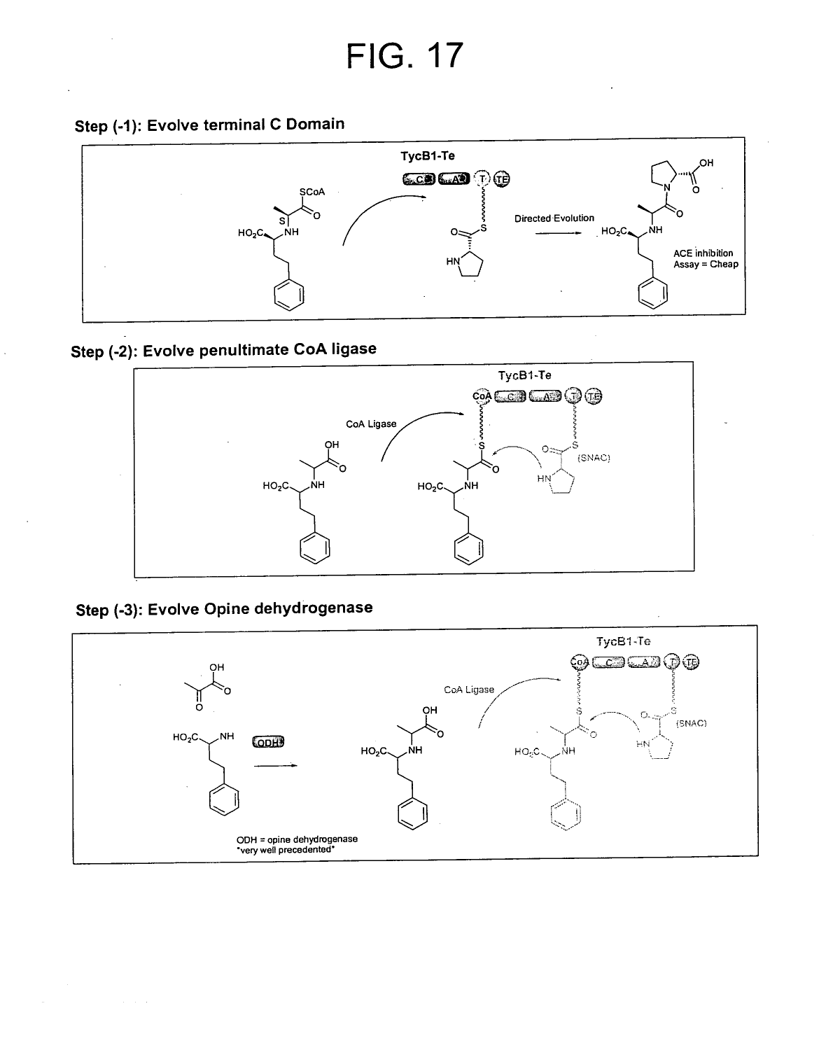

FIG. 17 is a scheme showing a bioretrosynthetic pathway for enalapril.

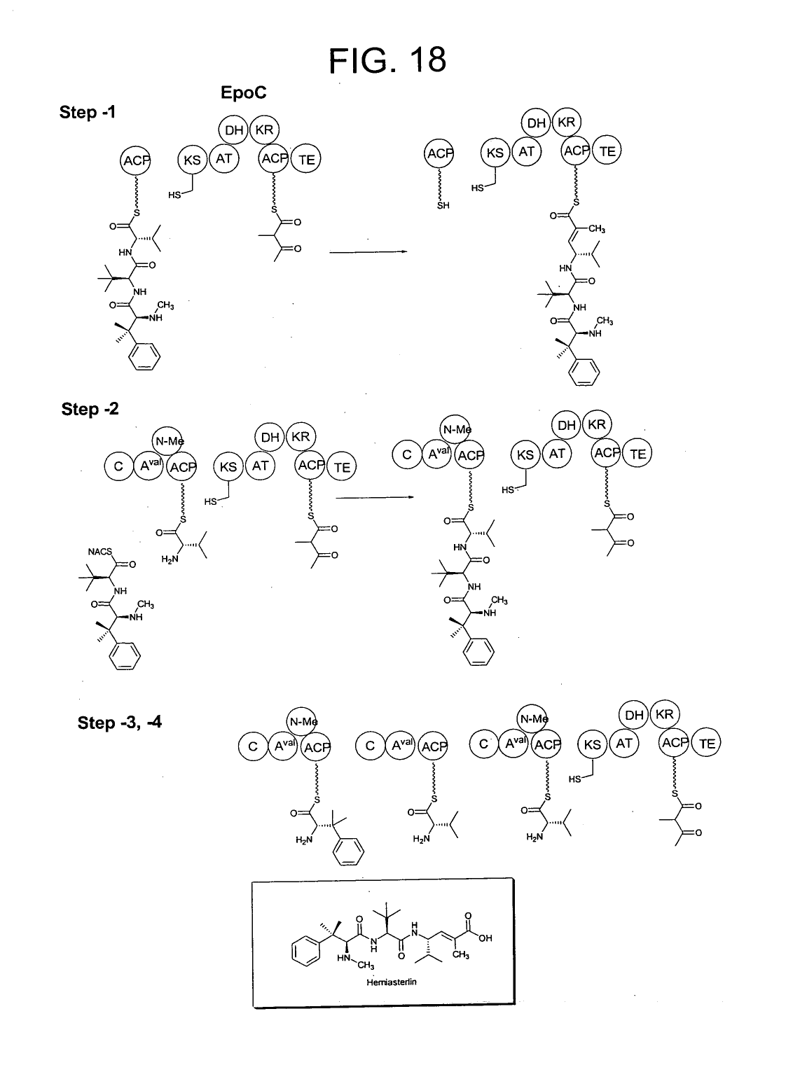

FIG. 18 is a scheme showing a bioretrosynthetic pathway for peptide/polyketide (hemiasterlin analogs). The assay can be cytotoxicity/tubule inhibition assay.

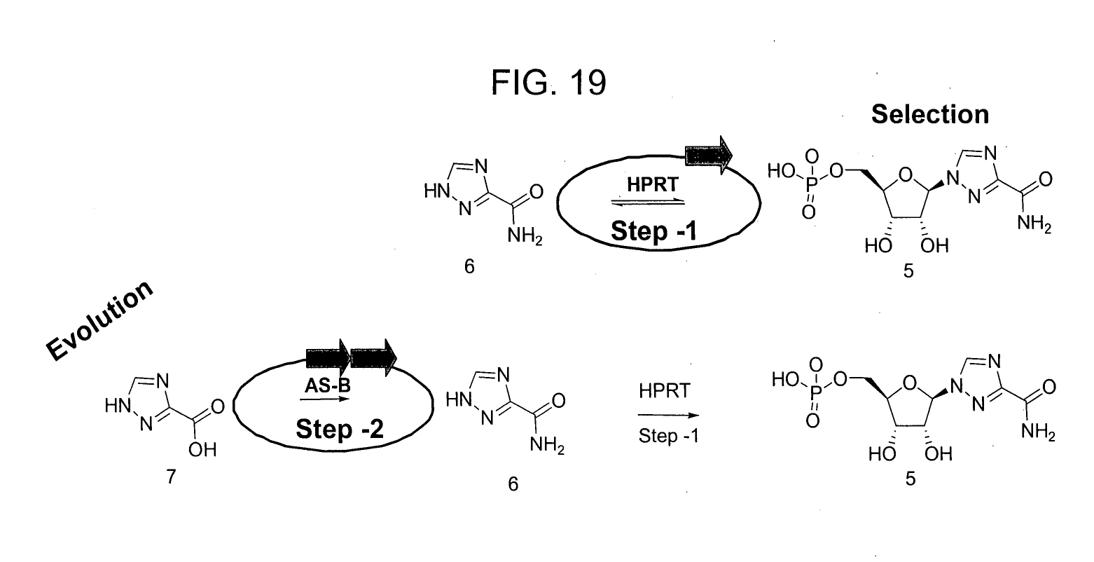

FIG. 19 shows a two step biosynthetic pathway for ribavirinMP synthesis.

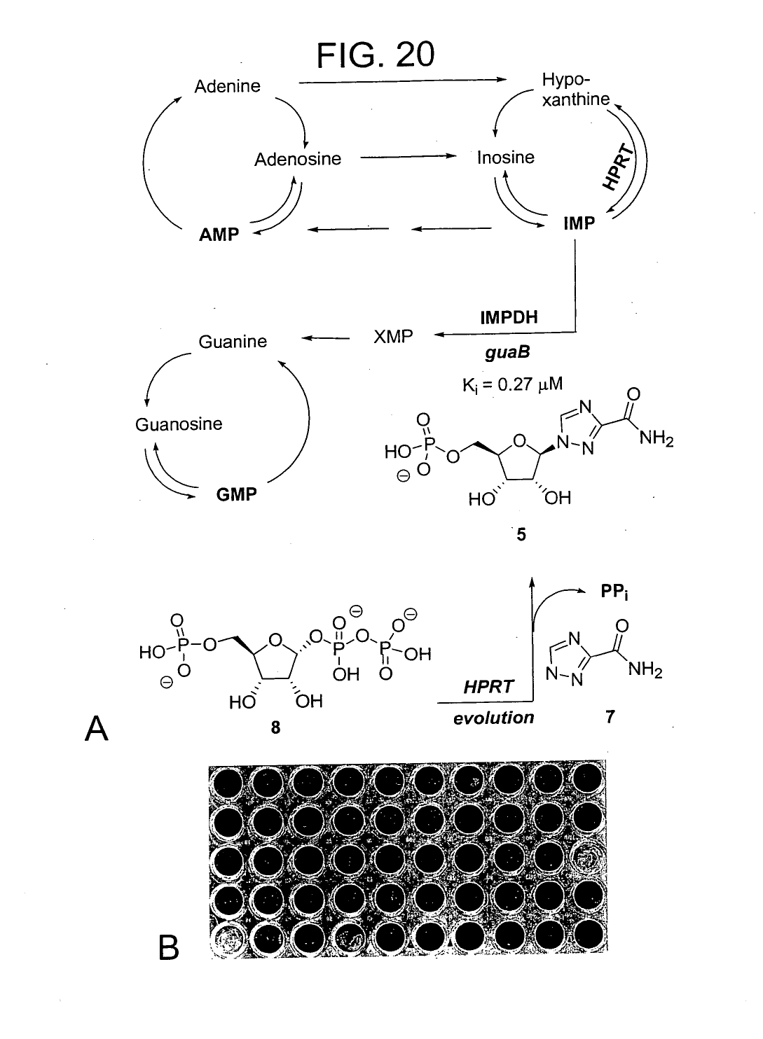

FIG. 20A shows an in vivo assay provides a means for selection in directed evolution of 1,2,4-triazole carboxamide phosphoribosyl transferase activity from HPRT. FIG. 20B shows A₆₀₀ of a portion of a 96-well plate indicating clones with various growth rates in presence of added triazole. Cell growth visualized with tetrazolium blue.

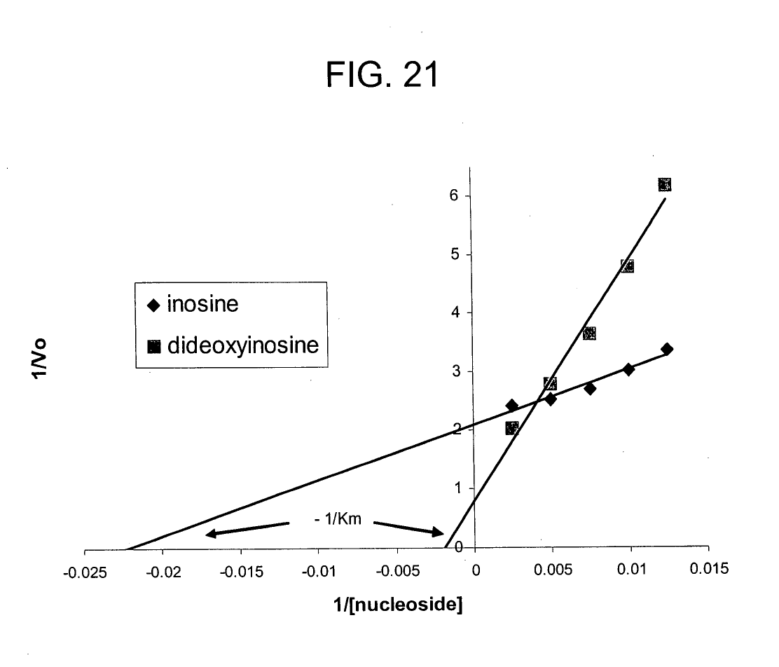

FIG. 21 is a double reciprocal plot of phosphorolysis of inosine vs. dideoxyinosine via PNP enzyme demonstrates basal activity for ddI pathway engineering.

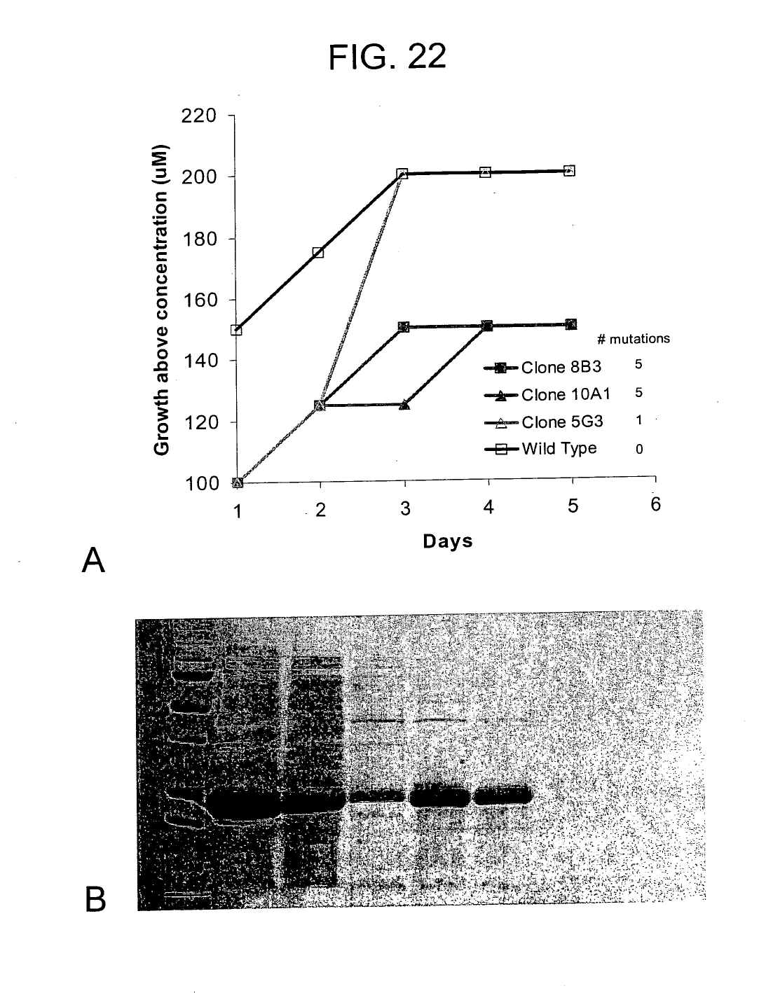

FIG. 22A is a graph of time course of sensitivity of clones identified by triazole sensitivity screening methodology. FIG. 22B is a SDS-PAGE gel of expression and nickel affinity purification of 8B3 HPRT. Left is cell-free extract and right is purified 8B3.

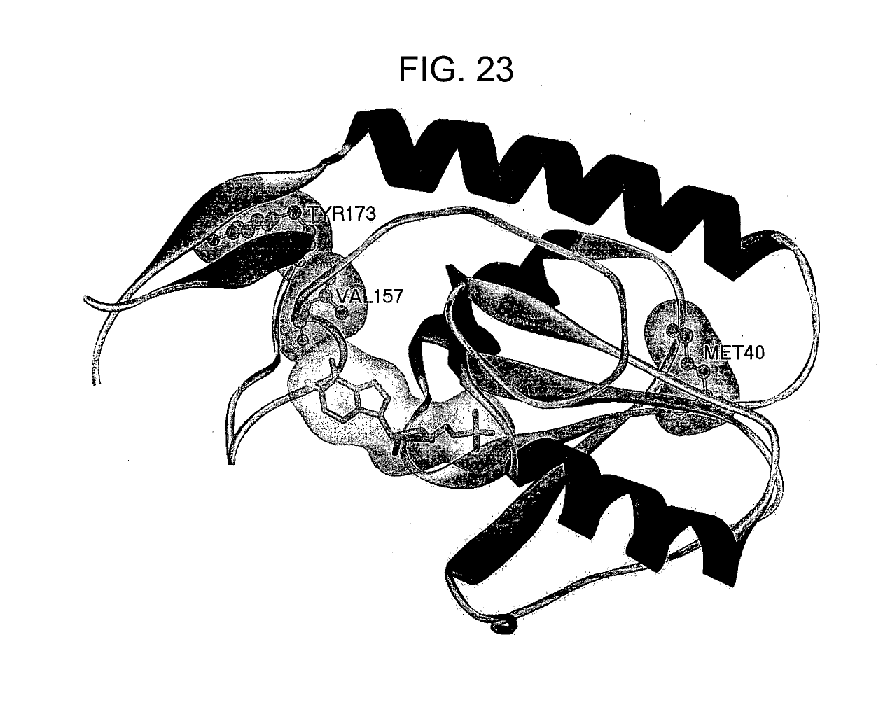

FIG. 23 is a K-12 HPRT crystal structure with IMP bound summarizing amino acid substitutions generated by directed evolution resulting in increased activity. Mutant 8B3 is a V157A Y173H double mutant.

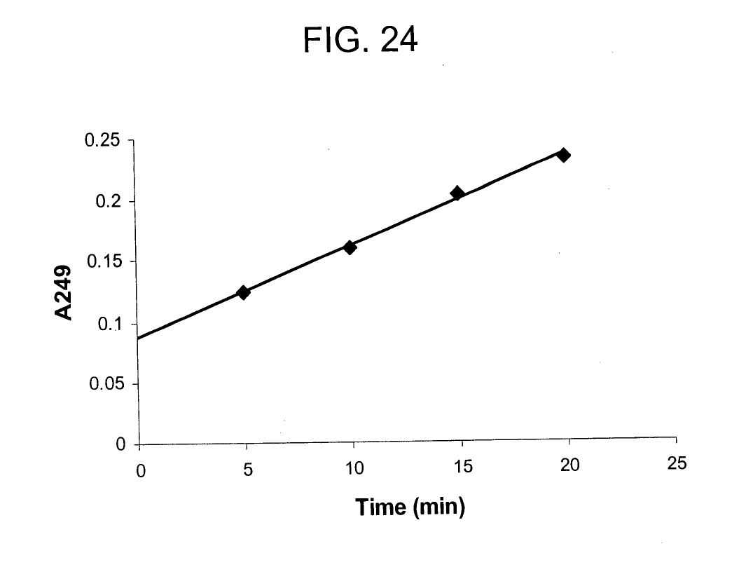

FIG. 24 is a graph showing the time course of IMP formation for nucleotide synthesis.

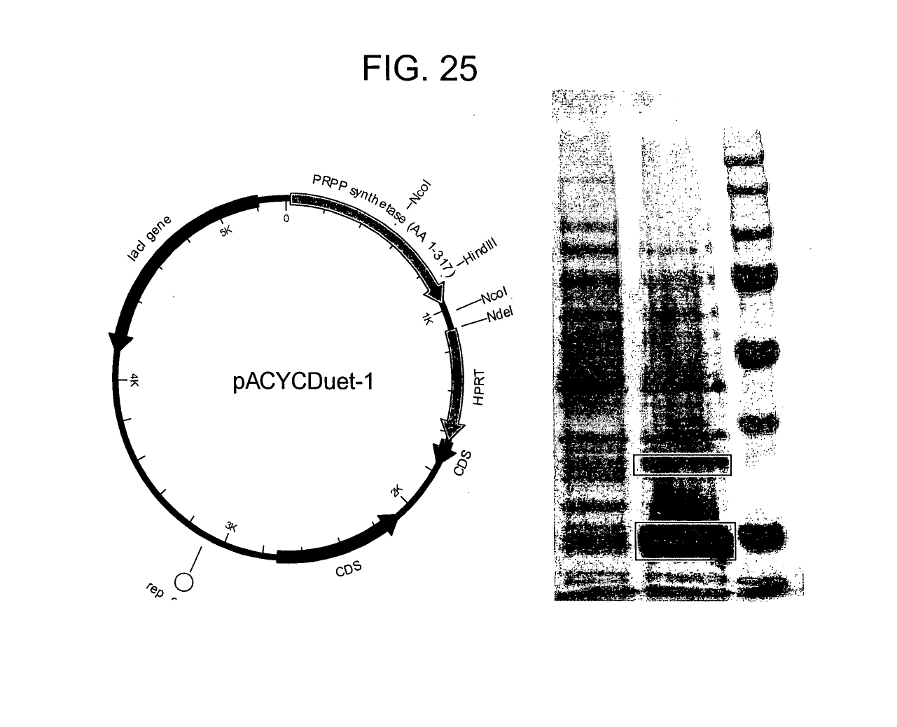

FIG. 25 is a SDS-PAGE gel of co-expressed HPRT (lower band) and PPRPS (upper band) co-overexpression in pET28-HPRT/pACYC-PPRPS cotransformant. Lane 1: soluble uninduced; lane 2: soluble induced; lane 3: marker.

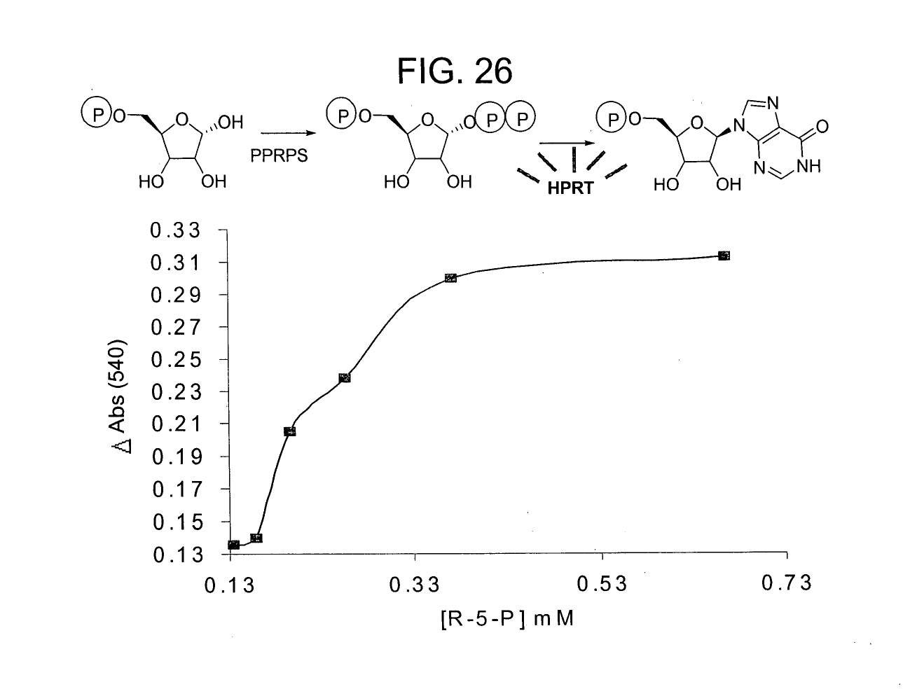

FIG. 26 is a graph and a scheme showing the tandem converstion of ribose-5-phosphate to IMP by cell free extracts from the pET28-HPRT/pACYC-PPRPS co-transformants.

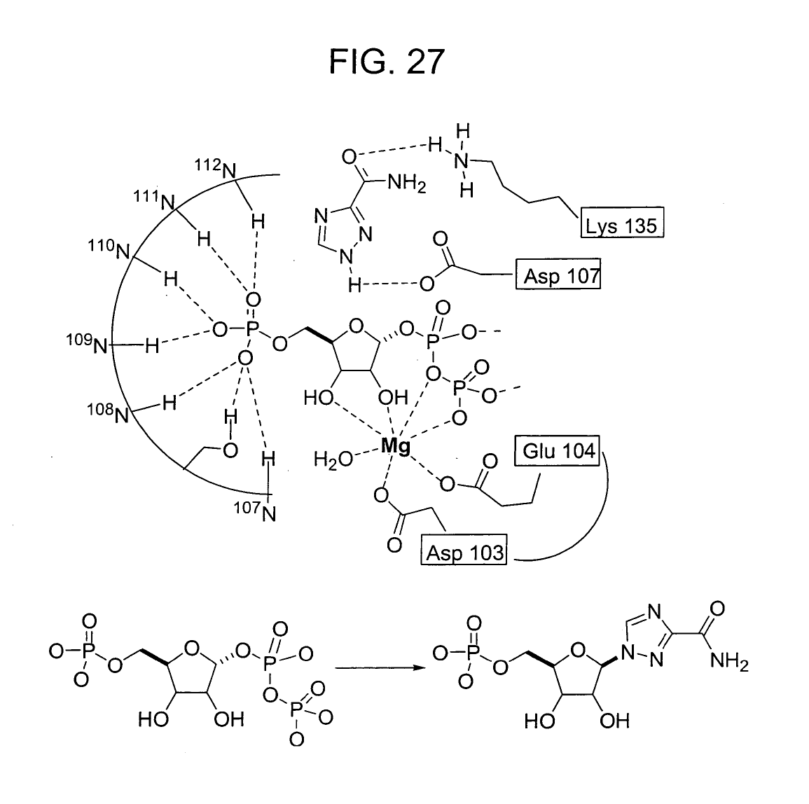

FIG. 27 is a diagram showing a hypothetical binding interaction for ribavirin monophosphate synthatse.

### VI. DETAILED DESCRIPTION

The materials, compositions, articles, devices, and methods described herein may be understood more readily by reference to the following detailed description of specific aspects of the disclosed subject matter, and methods and the Examples included therein and to the Figures and their previous and following description.

Before the present materials, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

A. Methods and Compositions

1. Definitions

Disclosed herein are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a molecule is disclosed and a number of modifications that can be made to a number of substituents are discussed, each and every combination and permutation that are possible are specifically contemplated unless specifically indicated to the contrary. Thus, if a class of substituents A, B, and C are disclosed as well as a class of substituents D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Throughout this specification, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

As used in the specification and the appended claims, the singular forms “a,” “an,” and “the” include plural referents unless the context clearly dictates otherwise. Thus, for example, reference to “a nucleotide” includes mixtures of two or more such nucleotides, reference to “an amino acid” includes mixtures of two or more such amino acids, reference to “the molecule” includes mixtures of two or more such molecules, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

By “reduce” or other forms of reduce means lowering of an event or characteristic. It is understood that this is typically in relation to some standard or expected value, in other words it is relative, but that it is not always necessary for the standard or relative value to be referred to. For example, “reduces phosphorylation” means lowering the amount of phosphorylation that takes place relative to a standard or a control.

By “inhibit” or other forms of inhibit means to hinder or restrain a particular characteristic. It is understood that this is typically in relation to some standard or expected value, in other words it is relative, but that it is not always necessary for the standard or relative value to be referred to. For example, “inhibits phosphorylation” means hindering or restraining the amount of phosphorylation that takes place relative to a standard or a control.

By “prevent” or other forms of prevent means to stop a particular characteristic or condition. Prevent does not require comparison to a control as it is typically more absolute than, for example, reduce or inhibit. As used herein, something could be reduced but not inhibited or prevented, but something that is reduced could also be inhibited or prevented. It is understood that where reduce, inhibit or prevent are used, unless specifically indicated otherwise, the use of the other two words is also expressly disclosed. Thus, if inhibits phosphorylation is disclosed, then reduces and prevents phosphorylation are also disclosed.

The term “therapeutically effective” means that the amount of the composition used is of sufficient quantity to ameliorate one or more causes or symptoms of a disease or disorder. Such amelioration only requires a reduction or alteration, not necessarily elimination. The term “carrier” means a compound, composition, substance, or structure that, when in combination with a compound or composition, aids or facilitates preparation, storage, administration, delivery, effectiveness, selectivity, or any other feature of the compound or composition for its intended use or purpose. For example, a carrier can be selected to minimize any degradation of the active ingredient and to minimize any adverse side effects in the subject.

Throughout the description and claims of this specification, the word “comprise” and variations of the word, such as “comprising” and “comprises,” means “including but not limited to,” and is not intended to exclude, for example, other additives, components, integers or steps.

The term “cell” as used herein also refers to individual cells, cell lines, or cultures derived from such cells. A “culture” refers to a composition comprising isolated cells of the same or a different type.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

“Primers” are a subset of probes which are capable of supporting some type of enzymatic manipulation and which can hybridize with a target nucleic acid such that the enzymatic manipulation can occur. A primer can be made from any combination of nucleotides or nucleotide derivatives or analogs available in the art which do not interfere with the enzymatic manipulation.

“Probes” are molecules capable of interacting with a target nucleic acid, typically in a sequence specific manner, for example through hybridization. The hybridization of nucleic acids is well understood in the art and discussed herein. Typically a probe can be made from any combination of nucleotides or nucleotide derivatives or analogs available in the art.

“Isolated,” as used herein refers to material, such as a nucleic acid or a polypeptide, which is: (1) substantially or essentially free from components which normally accompany or interact with it as found in its naturally occurring environment. Although, the isolated material optionally comprises material not found with the material in its natural environment; or (2) if the material is in its natural environment, the material has been synthetically (non-naturally) altered by deliberate human intervention to a composition and/or placed at a locus in the cell (e.g., genome or subcellular organelle) not native to a material found in that environment. The alteration to yield the synthetic material can be performed on the material within or removed from its natural state.

2. Directed Evolution

A number of theories for the evolution of biosynthetic pathways, primary or secondary, have been proposed and reviewed recently (Schmidt, S., et al., 2003. Metabolites: a helping hand for pathway evolution? Trends in Biochemical Sciences 28:336-341; Firn, R. D., and Jones, C. G. 2003. Natural products—a simple model to explain chemical diversity. Nat. Prod. Rep. 20:382-91). Two of these theories are shown in FIG. 2. The retro-evolution hypothesis proposes the pre-existence of a fitness imparting “product” molecule. Depletion of this molecule drives the evolution of an enzyme to convert a native precursor to this beneficial product (Horowitz, N. H., 1945, On the Evolution of Biochemical Syntheses, Proc. Natl. Acad. Sci. 31:153-157). Subsequent depletion of the precursor results in the evolution of an additional enzyme to catalyze the formation of the ultimate precursor from a penultimate precursor. The process continues with enzymes being evolved and assembled “retroconsecutively” to generate pathways from available precursors (i.e., primary metabolism).

FIG. 2 applies this hypothesis to the non-proteinogenic amino acid p-hydroxyphenylglycine, an important component of vancomycin-type antibiotics. In each evolutionary event, (Steps—1 to —3 in FIG. 2), the application of selective pressure is transmitted through the fitness imparting end-product.

Alternatively, there is mounting evidence supporting the recruitment theory in which new pathways evolve by recruitment of individual genes or gene cassettes from existing biosynthetic pathways (Jensen, R. A., 1976, Enzyme recruitment in evolution of new function, Annu. Rev. Microbiol. 30:409-425). In the example of p-hydroxyphenylglycine, FIG. 2 shows a mechanism in which suitable progenitor genes from primary metabolism are assembled and evolved in the forward direction. Unlike retro-evolution, each individual intermediate is required to possess fitness imparting properties. This theory is supported by the existence of enzyme superfamilies in primary metabolism.

In the methods disclosed herein, the recruitment theory and the retroevolution theory are combined in a new model and applied in the laboratory setting.

While not wishing to be bound by theory, individual biosynthetic enzymes are presumed to evolve by the stochastic processes of random mutation and the accumulation of beneficial mutation by homologous recombination. Analysis of gene sequences for natural product biosynthetic enzymes suggests that they frequently evolve from congeners in primary metabolism.

Table 1 shows putative examples of natural evolution of secondary metabolic enzymes from primary metabolic congeners. Table 1 also shows examples of successful application of directed evolution of biotransformations for various compounds. Specifically, Table 1 contains as illustrative examples β-lactam synthetase, which is apparently related to asparagine synthetase (Miller, M. T., et al., 2001, Structure of beta-lactam synthetase reveals how to synthesize antibiotics instead of asparagines, Nat. Struct. Biol. 8:684-689), antibiotic deoxysugar glycosyl transferases (Mulichak, A. M., et al., 2001, Structure of the UDP-glucosyltransferase GtfB that modifies the heptapeptide aglycone in the biosynthesis of vancomycin group antibiotics, Structure (Camb) 9:547-557) and CarB, 5-membered ring forming enzymes related to the enoyl hydrase/crotonase superfamily (Woo, A. J., et al., 1999, Nonactin biosynthesis: the product of nonS catalyzes the formation of the furan ring of nonactic acid, Antimicrob. Agents Chemother. 43:1662-1668; Li, R. F., et al., 2000, Three unusual reactions mediate carbapenem and carbapenam biosynthesis, J. Am. Chem. Soc 122:9296-9297).

TABLE 1

| Primary Metabolism | Secondary Metabolism |
|---|---|
| 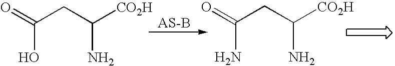 | 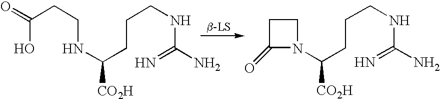 |
| 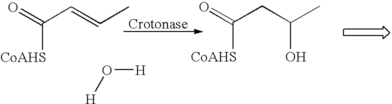 | 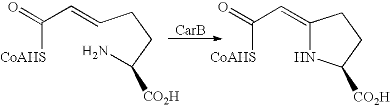 |
| 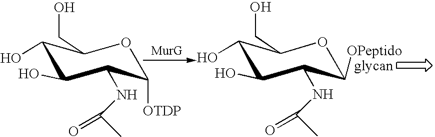 | 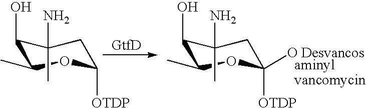 |

| Original Substrate | Evolved Activity | Improvement |
|---|---|---|
| 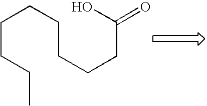 | 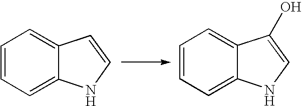 | new Activity |
| 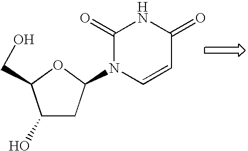 | 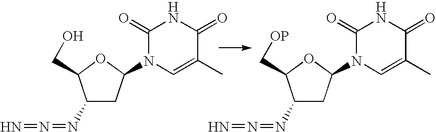 | 7-44 fold improved |
| 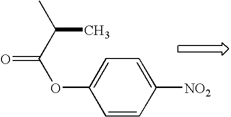 | 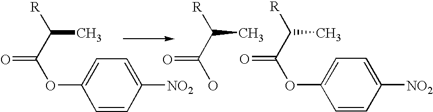 | ee increase from 2 to 81% |
| 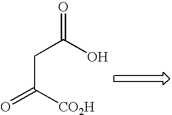 | 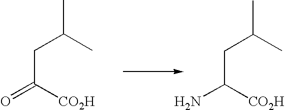 | 10⁵ improved. |

Enzymes are remarkably efficient catalysts. Biochemical analogs can be found for many synthetic transformations including hydrolysis, reduction, oxidation, carbon-carbon bond formation, and halogenation, to name but a few (Faber, K., 1995, Biotransformations in Organic Chemistry, 2nd ed. ed. Springer-Verlag, New York). However, for many years enzymes found limited use in synthetic chemistry because they were found to have poor tolerance for structurally divergent substrates, functioned under a limited range of reaction conditions, and required expensive cofactors and reagents for application. Some of these issues have been addressed with the advent of directed evolution methodologies which have an excellent track record of improving or modifying enzyme activities and properties to a desired physiochemical phenotype (Arnold, F. H., 1997, Design by directed evolution, Faseb Journal 11 :A872-A872; Tao, H., and Cornish, V. W., 2002, Milestones in directed enzyme evolution, Curr. Opin. Chem. Biol. 6:858-864). In these methods a large library of enzyme variants is created in a host organism library, and the organism library is assayed for its ability to catalyze the desired chemistry under selected conditions. One challenge to this method is the screening process, which should be specific to the target chemistry, and amenable to high throughput analysis (Arnold, F. H., and Geotgiou, G., 2003, Directed Enzyme Evolution, Screening and Selection Methods, vol. 230. Humana Press, Totowa, N.J.). When a robust screen is developed, enzyme improvement is impressive, and examples of numerous biosynthetic success stories have been reviewed (Farinas, E. T., et al., 2001, Directed enzyme evolution, Curr. Opin. Biotechnol. 12:545-551), a few of which are shown in Table 1.

In one example, the nucleoside analog AZT was processed by thimidine kinase with an improved activity versus the wild-type by 16,000 fold with four rounds of molecular breeding (Christians, F. C., et al., 1999, Directed evolution of thymidine kinase for AZT phosphorylation using DNA family shuffling, Nat. Biotechnol. 17:259-264). In cases where a more drastic switch in substrate specificity is desired, directed evolution can be combined with rationally selected point mutations (Jurgens, C., et al., 2000, Directed evolution of a (beta alpha)8-barrel enzyme to catalyze related reactions in two different metabolic pathways, Proc. Natl. Acad. Sci. USA 97:9925-9930). In any event, directed evolution is a powerful methodology for improving individual enzyme activity, or at least relaxing substrate specificity (Schmidt, D. M., et al., 2003. Evolutionary potential of (beta/alpha)8-barrels: functional promiscuity produced by single substitutions in the enolase superfamily. Biochemistry 42:8387-8393), of existing biosynthetic enzymes.

Molecular biological methodology has addressed the practical issue of artificial gene/enzyme assembly into multi-step pathways in the laboratory setting. A “multi-plasmid approach,” in which genes are introduced on separate vectors with unique biological markers, has been employed in reconstruction of engineered polyketide biosynthesis (Xue, Q., et al. 1999. A multiplasmid approach to preparing large libraries of polyketides. Proc. Natl. Acad. Sci. USA 96:11740-11745; Hertweck, C. 2000. The multiplasmid approach: a new perspective for combinatorial biosynthesis. Chembiochem. 1:103-106), and is especially useful for multi-protein systems with the caveat that the number of plasmids introduced is limited by the number of distinct compatible biosynthetic markers and origins of replication. The carbapenem biosynthetic pathway in E. coli was effectively reconstructed using an alternate approach, in which genes were assembled on a single plasmid by sequential ligation of the genes, each with an inducible upstream promoter (Li, R. F., et al., 2000, Three unusual reactions mediate carbapenem and carbapenam biosynthesis, J. Am. Chem. Soc. 122:9296-9297). Expression systems for heterologous protein overexpression have become commercially available. The Novagen DUET™ system (Novagen, San Diego, Calif.), for example, allows the simultaneous co-overexpression of up to eight proteins.

Disclosed herein, evolutionary processes can be modeled and harnessed for the application of de novo product pathway construction.

Mimicking the stochastic forward evolutionary process would require library populations well out of range of laboratory methods. Likewise, stepwise construction of a biosynthetic pathway, by forward evolution of multiple individually optimized enzymes (by directed evolution for instance), would require the development of multiple screens for potentially non-bioactive intermediate metabolites (FIG. 3). Conversely, the retro-evolution methods disclosed herein are practicable in the laboratory, where the products, intermediates, and selection means can be provided. In this way laboratory retro-evolution can circumvent the necessity for multiple assays in forward concatenation.

The methods and compositions disclosed herein include a biological application of recruitment-retrosynthesis, in which a pathway is envisioned via a series of reverse stepwise bio-disconnections. Individual enzymes are identified as recruitment candidates for the construction of new pathways, and these enzymes are assembled and optimized retro-consecutively to assemble a new pathway. This process is termed “bioretrosynthesis” herein. In bioretrosynthesis, pathways are evolved retro-consecutively in a manner similar to the classical heuristic process of retrosynthesis.

3. Methods

Accordingly, in one aspect, disclosed herein are methods and compositions for determining how natural product biosynthetic enzymes evolve and for understanding the design rules for their concatenation into efficient “total syntheses” of natural products. These rules can be applied to direct the evolution of such pathways into new biosynthetic pathways for natural and non-natural molecules.

In another aspect, disclosed herein are compositions and methods for evolving biosynthetic pathways in a reverse step-wise fashion, similar to the chemical process of retrosynthesis. In this approach, termed “bioretrosynthesis,” directed evolution can be used to optimize individual enzyme activities and biosynthetic pathways can be assembled from individual enzymes retroconsecutively, from the last transformation to the first. Selective pressure (e.g., screening) for each step can be provided by screening for the last biotransformation. Earlier biotransformations along the pathway can be assayed via their tandem conversion to a precursor for the last biotransformation.

The method and compositions disclosed herein are generalizable to any multistep biosynthetic pathway. Further, bioretrosynthesis according to the methods described herein can be developed to synthesize any target product (e.g., clinically important products like dideoxyribose nucleoside analogs) in living systems (e.g., E. coli). These systems are readily adaptable to produce complex natural and non-natural products including, for example, nucleoside analog antiviral compounds based on other scaffolds. Additional applications include so-called “modular” systems of nonribosomal peptide and polyketide synthetases.

The new methods are a powerful new means of assembling and studying biosynthetic pathways. For example, as described below, the number of assays needed to engineer a given biosynthetic pathway by directed evolution can be reduced from n assays, where n is the number of steps in the biosynthetic pathway, to one. Also, an end product of the disclosed method is an evolved “operon,” which can be mobilized into other heterologous hosts and can be used as a starting point for combinatorial biosynthesis. Further, the disclosed methods and compositions can be used to produce clinically important “non-natural” products via fermentation based synthesis. The disclosed methods and compositions can also provide insight into the evolution of natural product biosynthetic pathways and into sequence/structural determinants in enzyme mechanism of primary metabolic enzymes.

The disclosed compositions and methods can be described in reference to FIG. 1. The steps in the method are identified in FIG. 1 as 1^{st} iteration, 2^{nd} iteration, 3^{rd} iteration, etc. and the compounds of the method are identified as B, C, D, etc. It is understood that these identifiers for the various iterations and compositions are for the purposes of describing the method and are not intended to be limiting. For example, the disclosed methods can have many iterations (beyond the five iterations shown in FIG. 1) and many compounds (beyond the five shown in FIG. 1). Thus the method can comprise n iterations and n compounds.

The methods generally involve a target molecule, precursor molecules, a target molecule assay, and precursor enzymes. One goal is to make a single genetic unit, such as an operon, in which all of the enzymes needed to take a simple starting material through to a target molecule are present. The reagents and methods steps that can be used to achieve this are discussed herein.

It is understood that the nomenclature disclosed here for the general method is applicable to each specific example discussed herein. For example, it is understood that rabavirin monophosphate can be considered a target molecule and each retrosynthetic molecule for its production can be considered a precursor. For example, another target molecule can be the class of molecules call nucleoside analogs or antibiotics etc.

a) Target Molecules

In one aspect, the disclosed method begins by selecting a target molecule to synthesize via bioretrosynthetic method. This molecule is identified by the letter “F” in FIG. 1. This molecule can be referred to as the target molecule. By the methods disclosed herein, the target molecule can be any molecule, natural or non-natural (e.g., nucleoside analogs). In some examples, the target molecule can be a natural product, non-natural product, pharmaceutical, nucleotide, amino acid, lipid, carbohydrate, steroid, vitamin, antibiotic, factor, chemokine, derivatives and analogs thereof. In other examples, the target molecule can be a nucleoside analog, such as the nucleoside analogs disclosed herein, which are agents in amelioration of several viral pathologies including HIV (human immunodeficiency virus), HBV (hepatitis B virus), HCV (hepatitis C virus), HSV (herpes simplex virus), and HCMV (human cytomegalovirus). New transformations provided by the methods disclosed herein will expand the tools available for the synthesis and discovery of new drugs, provide new production methods for these valuable compounds, and expand public availability via fermentation derived synthesis. In still other examples, the target molecule is ribavirin, ribavirin monophosphate, dideoxyinosine, dideoxyinosine monophosphate, a non-ribosomally encoded peptide, a polyketide, alkaloid, shikimate derived, sugar derived (polysaccharide), or a mixed biosynthesis product.

In additional examples, the chemical structures of further nucleoside analogs, which are approved by the FDA for treatment of HIV infection are shown below.

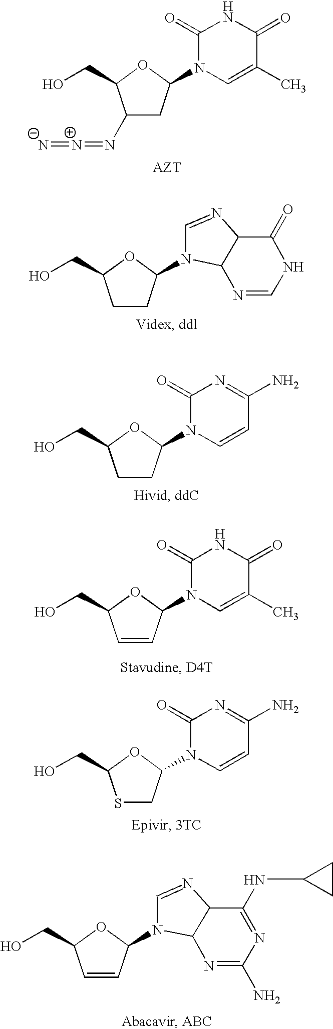

b) Precursor Molecules

A precursor molecule is a molecule which with one chemical transformation will become another molecule. Used herein is the first, second, third, or fourth etc. precursor molecules. This designation implies that the molecule the precursor will be transformed into will be the n-1 precursor molecule. For example, the fourth precursor molecule will be transformed into the third precursor molecule and the third precursor molecule will be transformed into the second precursor molecule and the second precursor molecule will be transformed into the first precursor molecule. The designation “first precursor molecule” will be transformed into the target molecule.

It is understood that there can be any number of precursor molecule in the disclosed method. The number will be determined by the number of steps needed to achieve the biosynthesis of the target molecule. It is understood that every number up to 100 transformations is disclosed. These can be designated as precursor 1, precursor 2, precursor 3, precursor 4, precursor 5, precursor 6, precursor 7, precursor 7, precursor 8, precursor 9, precursor 10, precursor 11, precursor 12, precursor 13, precursor 14, precursor 15, precursor 16, precursor 17, precursor 18, precursor 19, precursor 20, and so forth up to precursor 100, but that any number of precursors can be used and are disclosed. It is understood that, for example, precursor 14 will be transformed into precursor 13, and so forth.

In FIG. 1, for example, precursor E leads to target molecule F, and precursor D leads to precursor E, and precursor C leads to precursor D, and so forth, which is another way of indicating the relationships between the precursor molecules (A-E) and the target molecule (F).

Each precursor molecule is chosen and designed based on the property of moving from the precursor to another molecule in one transformation. This step is analogous to a process of retrosynthesis and can be readily performed by those of ordinary skill in the art. Principles of retrosynthetic analysis are provided in, for example, Warren, S., Organic Synthesis: The Disconnection Approach, John Wiley & Sons, N.Y. 1996. Generally, a bond(s) in the structure of the target molecule that can be prepared by a given chemical transformation(s) is identified. This bond(s) is then “disconnected” in the structure of the target molecule to yield the structure(s) of the precursor(s) radical. The precursor(s) is then identified by transforming the radical moiety of the precursor(s) radical to a suitable functional group that, when reacted, provides the “disconnected” bond. It is understood, as discussed herein, that while in a purely retrosynthesis world, where the target molecule will be synthesized in a wet lab situation, there are often many possible precursors and one precursor is chosen because of a combination of characteristics, including but not limited to, ease of making, ease of purification, cost of making, efficiency of making, and so forth. So to in the bioretrosynthetic methods disclosed herein there can be multiple considerations given in choosing a particular precursor, but one consideration can be based on the knowledge of known enzymes. A particular precursor may be chosen because of the knowledge of a particular enzyme that will perform a reaction similar or the same as the desired transformation of the precursor. Likewise, just as in traditional synthetic chemistry there is a “grab bag” of reactions that the synthetic chemist can turn to, likewise in bioretrosynthetic methods there will be an ever expanding “grab bag” of enzymes that will be available for building the disclosed pathways. It is understood, however, that when a given enzyme for a given reaction does not exist, directed evolution, and other screening methods allow for the isolation of enzymes having a new and desired property.

In another aspect, the precursor(s), such as the first precursor or precursor 1, for the target molecule, can be known.

Once the precursor(s) is identified, it can be synthesized in sufficient quantities for high-throughput screening/selection in directed evolution experiments. The precursor(s) can be readily synthesized using techniques generally known to those of skill in the art. The starting materials and reagents used in preparing these compounds are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989). Alternatively, the precursor(s) can be purchased from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.). It is also possible that the precursor(s) are all ready existing molecules that can be either isolated or purchased.

c) Precursor Enzymes

In one aspect of the disclosed method, each precursor molecule will have or become associated with one enzyme that transform that particular precursor molecule into the molecule the precursor molecule is to become. For example, a second precursor molecule is designed to be transformed into a first precursor molecule and this can be accomplished by a precursor enzyme 2, or a second precursor enzyme. Just as there can be any number of precursor molecules so to there can be any number of precursor enzymes. In certain embodiments there will always be the same number of precursor enzymes as precursor molecule, one enzyme for each precursor molecule transformation. As discussed herein, such as in the Examples, in certain aspects each precursor enzyme will be isolated using, for example, directed evolution, for each precursor molecule. As each precursor enzyme is identified it can be added into the target molecule pre-operon(s) or operon(s), and then added to the reaction pathway. The isolation, manipulation, making, purification, genetic manipulation, and all other manipulations discussed herein for each specific enzyme are understood to be generally disclosed for all enzymes as needed.

d) Target Molecule Pre-Operon and Target Molecule Operon

As discussed herein, one goal of the disclosed methods and compositions is to create a target molecule biosystem pathway. A target molecule biosystem pathway is the set of chemical transformations needed to take a starting molecule, such as a sugar or amino acid, and transform it into a desired target molecule, such as a nucleoside analog, such as ribavirin or dideoxyinosine. It is understood that the target molecule biosystem pathway can contain any number of transformations, such as 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 or more transformations.

Another goal of the disclosed methods and compositions is to make a target molecule operon(s). A target molecule operon is a genetic construct that contains multiple enzymes which are the enzymes needed to perform the transformations of the target molecule biosystem pathway. In certain embodiments the target molecule operon will contain all of the enzymes needed for each transformation of the target molecule biosystem pathway.

The operons are constructed as disclosed herein and understood such that genetic control of each enzyme is operably linked such that each enzyme is appropriately expressed and regulated.

Also disclosed are target molecule pre-operon(s). These are molecules that contain a subset of the complete target molecule biosystem pathway enzymes which are required. Furthermore, a pre-operon can also contain a library of potential second precursor enzymes linked to a known first precursor enzyme, for example, which can be used to identify the second precursor enzyme from the potential second precursor enzymes. Typically a pre-operon is what is used for the identification of each next retro precursor enzyme. For example, the target molecule can be made by transforming precursor 1 via the enzymatic manipulation of precursor 1 enzyme. The precursor 1 enzyme can then be put into a target molecule pre-operon containing the precursor 1 enzyme and a library of potential precursor 2 enzymes operably linked. This particular target molecule pre-operon can then be used to identify the precursor 2 enzyme, which can then be linked in another target molecule pre-operon containing, precursor 1 enzyme, precursor 2 enzyme and a library of potential precursor 3 enzymes operably linked, which can then be used to identify the precursor enzyme 3.

It is understood that just as for the precursor molecules and precursor enzymes there can be any number of target molecule pre-operon(s), and these can be designated as target molecule pre-operon 1, target molecule pre-operon 2, and so forth, where the numerical designation of the pre-operon can be linked to the numerical precursor. For example, a target molecule pre-operon 3 could contain a library of potential precursor 3 enzymes, as well as the precursor 2 enzyme and the precursor 1 enzyme, all operably linked. In other words, for every precursor molecule there can be a target molecule pre-operon.

4 Method Steps

The disclosed methods can comprise a number of different activities and steps, and the steps can be repeated any number of times in any combination. For example, the methods can include the design and/or decision of the target molecule. The methods can also include the design and/or synthesis of precursor 1 as well as all of the other precursors that may be part of a given bioretrosynthetic pathway. The design of the precursors can involve steps including retrosynthesis steps as well as actual synthesis of the designed molecule. The methods can include the step of isolating an enzyme that will convert a precursor to either a precursor (n-1) or into the target molecule. The step of isolating can include many steps including the production of, for example, a pre-operon, capable of expressing a library of potential precursor enzymes, producing the cells containing and/or expressing the pre-operon, producing the culture conditions for the cells containing the pre-operon and so forth. The methods can also include an incubation step where the precursor is incubated with a biosystem expressing a pre-operon which is expressing a precursor enzyme library related to the particular precursor. The methods can also include an assay step wherein a cell or set of cells expressing a particular pre-operon designed to identify a particular precursor enzyme is assayed for their abilty to transform the precursor to the molecule the precursor was designed to be transformed into. The methods can also include the step of selecting the cell or cells capable of performing a particular precursor transformation. The methods can also include the step of amplifying any of the cells or nucleic acids at any point in the method. The methods can also include the step of repeating one or more of the steps with a different precursor molecule and all of the consequent differences driven by that different precursor. It is understood that the examples provide different illustrations of the steps and way that various steps can be performed. The method can also include the step of cloning and sequencing of the identified selected precursor enzyme from the population of potential precursor enzymes from within the particular target molecule pre-operon.

a) Precursor Design

As discussed above, precursors can be made using any synthetic method, such as those disclosed herein.

b) Incubation

At the first level of the method there is a target molecule, a first precursor molecule, a target molecule assay, and a first precursor enzyme, either possessed or which will be isolated via directed evolution. In certain embodiments the precursor enzyme may exist and in other embodiments the method involves the process of isolating an enzyme that will transform the first precursor molecule to the target molecule, typically in a biosystem. The isolation of an enzyme using directed evolution or other techniques is discussed extensively in the Examples. Once this enzyme is obtained the enzyme will form one of the enzymes in the pathway for synthesizing the target molecule. Once the precursor (e.g., compound “E” in FIG. 1) is obtained, it can incubated with a selected population of cells. The selected population of cells can contain a library of expressible genes.

The selected population of cells can be the same type of cells or a mixture of different types of cells. The cells in the selected population of cells can be of any cell type, from any tissue, and from any organism. For example, cells can be derived from any eukaryotic or prokaryotic species and can be differentiated, undifferentiated, de-differentiated, or immortalized. In one aspect, the disclosed methods can be carried out on cells of eukaryotic origin, such as fungus, plant, or animal, or of prokaryotic origin, such as bacteria or yeast. A selected population containing cells of eukaryotic origin can be derived from any eukaryotic species, including, but not limited to, mammalian cells (such as rat, mouse, bovine, porcine, sheep, goat, and human), avian cells, fish cells, amphibian cells, reptilian cells, plant cells, yeasts, and the like. In another aspect, the selected population of cells include cells of vertebrates and particularly mammals, more particularly, rats and mice, and more particularly humans. In another aspect, the selected population of cells derived from any of these sources can be primary or can be immortalized cell lines, including, for example hybridomas constructed from different species.

Further, cells can be derived from any tissue in an organism. Examples of useful tissues from which a selected population of cells can be obtained include, but are not limited to, liver, kidney, spleen, bone marrow, thymus, heart, muscle, lung, neural (such as brain, spinal cord, or ganglion), testes, ovary, islet, intestinal, skin, bone, stomach, gall bladder, prostate, bladder, zygotes, embryos, immune cells (including lymphatic), hematopoietic cells, and the like. Examples of plant tissues from which a selected population of cells can be derived include, but are not limited to, leaf tissue, ovary tissue, stamen tissue, pistil tissue, root tissue, gametes, seeds, embryos, and the like. Also, these cells can be taken from organisms under normal basal conditions, under naturally occurring or induced disease states or following some sort of activation, stimulation or other perturbation of the organism, including, for example, genetic, pharmacologic, surgical, pathogenic, or therapeutic manipulations.

The choice of the cell population can be made by one of ordinary skill in the art. The choice will depend on the particular desires and aims of the researcher. For example, cells know to express certain enzymes that can transform the precursor into the target molecule (e.g., the 1^{st} iteration in FIG. 1) can be selected.

Procedures for incubating a cell in the presence of a compound are known. For instance, transformation of AZT to 5′-phospho-AZT was accomplished by incubating AZT with E. coli containing heterologously expressed evolved adenosine thymidine kinase (Christian et. al, Nature Biotechnology March 1999;17(3):259-64.)

c) Assay and Selection

After the selected population of cells has been incubated in the presence of the precursor (compound “E” in FIG. 1), the cells that produce the target molecule (compound “F” in FIG. 1) are identified. Identification of cells that produce the target molecule can be performed by any assay known in the art. For example, the assay can be for the target molecule itself (e.g., increases in compound “F”). Alternatively, the assay can be for the precursor of the target molecule (e.g., decreases in compound “E”). Further, the assay can be for the generation of some conjugate or derivative of the target molecule. Still further, the assay can be for some by-product of the chemical transformation of the precursor to the target molecule.

The production of the target molecule can be measured by methods known to those of skill in the art, such as, but not limited to, high performance liquid chromatography (HPLC), gas chromatography (GC), gas chromatography mass spectrometry (GCMS), nuclear magnetic resonance (NMR), electrophoresis, and the like. Other methods include, but are not limited to biochemical assays, for instance enzymatic assays resulting in a detectable UV or fluorescent chromophore, or in vivo biological assays in which the target molecule gives the cell a survival advantage (for example antibiotic resistance) or results in the retardation of growth or death of the cell (for example converts a protoxin to a toxin under defined conditions).

d) Precursor Enzyme Cloning

Once the cells that produce the target molecule are identified, the genes that encode the enzyme, found with the target molecule pre-operon that are responsible for converting the precursor to the target molecule (for example “GeneEF” or precursor “n” enzyme), can be isolated from the cells producing the target molecule. The cloning and isolation of the genes from within the pre-operon can be performed using standard molecular biology techniques.

e) Pre-Operon Construction

After a particular precursor enzyme is isolated and cloned, the gene encoding that precursor enzyme can be cloned into a different pre-operon containing the cloned gene operably linked to a library of another set of potential precursor enzymes, for a different precursor, as well as to any other precursor enzymes, already identified for the target molecule biosystem pathway. The gene isolated from the previous iteration of precursor enzyme isolation (e.g., GeneEF, or precursor “n” enzyme) can then be inserted into a secondary population of cells containing a secondary library of expressible genes. The isolated genes (e.g., GeneEF) can be inserted into the secondary population of cells such that the isolated gene (e.g., GeneEF) and the secondary library of expressible genes are both expressed. It is understood that the library of potential precursor enzymes can be on the pre-operon or they can be on a separate expression system within the cell.

The secondary population of cells can be of any manner, type, and form, as disclosed above. Also, the secondary library of expressible genes can be as described herein.

f) Iterations

Next the secondary population of cells containing the inserted genes (i.e., GeneEF and the secondary library of expressible genes) can be incubated with a secondary precursor (i.e., compound “D” in FIG. 1). This can be done in a manner similar to that described above where the precursor (compound “E”) was incubated with the selected population of cells.

The secondary precursor (e.g., compound “D”) can be identified and obtained just as the other precursor described above (i.e., compound “E”). Specifically, the precursor can be identified by retrosynthetic analysis from the product of the precursor. In this example, the secondary precursor identified as compound “D” can be identified by retrosynthetic analysis from compound “E.” Once identified, the secondary precursor can be prepared by methods known in the art or obtained commercially.

After incubating the secondary precursor with the secondary population of cells, which express both the isolated gene from the first step (i.e., GeneEF) and the secondary library of expressible genes, the cells or cell-free extract that produce the target molecule are identified as described above. That is by using the same assay as discussed above for the production of the target molecule, cells that can produce the target molecule (i.e., compound “F”) when incubated in the presence of the secondary precursor (i.e., compound “D”) can be identified.

The gene responsible for the transformation of the secondary precursor (compound “D”) to the first precursor (compound “E”) can be identified and isolated. This gene can be called “GeneDE”, for example, and it can be inserted into a tertiary population of cells which contain a tertiary library of expressible products and the first isolated gene (e.g., GeneEF).

As is evident, these steps can be repeated as many times as there are steps in the biosynthetic pathway. The number of steps will of course depend on the complexity of the molecule being synthesized, the selected precursors, the availability of suitable starting materials from which the biosynthetic pathways is desired to begin, and researcher preference.

In other words, the method disclosed herein can be repeated in any number of iterations. The number of iterations involved in the disclosed method will correspond to the number of steps in the bioretrosynthetic pathway. Also, the first iteration of the disclosed method corresponds to the last chemical transformation needed to make the target molecule. The last iteration in the disclosed method will correspond to the first step in the bioretrosynthetic pathway (see FIG. 1).

According to the disclosed methods, bioretrosynthesis can be extended to all classes of natural products and non-natural products and to facilitate combinatorial biosynthesis of novel chemical structures. As a model of the evolutionary theory of retro-evolution, the methods disclosed herein also provide insight into the evolutionary mechanisms of natural product biosynthetic pathways. As a synthetic paradigm, this concept can provide alternatives for the synthesis and production of target molecules (e.g., clinically important nucleosides and nucleoside analogs), provide new synthetic methods for target molecules, and be used to produce libraries of new analogs (e.g., from nucleoside-like scaffolds).

As with retrosynthesis, the bioretrosynthetic methods disclosed herein simplify biosynthetic pathway design. But unlike retrosynthesis, bioretrosynthesis is a combination of a laboratory method and an evolutionary model. In a pathway with N biocatalytic steps, bioretrosynthesis decreases the number of unique assays necessary for pathway evolution, (from N-assays to one), versus forward concatenation. There are other practical advantages of creating biosynthetic pathways in vivo. New synthetic transformations and catalysts are developed as part of the evolutionary process and can be employed as starting points for other biosyntheses. Blocked pathways can be created, providing biosynthetic routes to intermediates and or shunts in the synthetic pathway. Fermentation derived production of non-natural products can be performed. Gene “cassettes” of short biosynthetic pathways can be combined to create highly complicated structures. This can also be used as a starting point for combinatorial biosynthetic studies. (Fu, X., et al., 2003, Antibiotic optimization via in vitro glycorandomization, Nature Biotechnol. 21:1467-1469; Yang, J., et al., 2004, Natural product glycorandomization, Bioorg. & Med. Chem. 12:1577-1584). Providing new cassettes for producing novel substructures can facilitate such efforts.

As noted herein, nucleosides and nucleoside analogs and other classes of molecules can be synthesized by the disclosed methods. Many currently non-natural compounds can be amenable to biodisconnection and bioretrosynthesis. There are only two requirements for implementation in cell-free systems: (1) a robust product (or ultimate activity) assay and (2) synthetic route for proposed biosynthetic intermediates. If toxicity and/or transport pose problems in whole cells, then other experiments can address these issues in subsequent studies. Even as a cell-free execution, however, bioretrosynthesis can be used to evolve other “non-natural” compounds, such as polyketides and non-ribosomally encoded peptides, by retro-consecutive modular concatenation. Thus, a biosystem in its broadest form does not require a cell, but rather it requires the components necessary for the precursor and potential precursor enzymes to function to perform their respective transformations of precursor molecules.

5. General Nucleic Acid and Peptide

a) Sequence Similarities

It is understood that as discussed herein the use of the terms homology and identity mean the same thing as similarity. Thus, for example, if the use of the word homology is used between two non-natural sequences it is understood that this is not necessarily indicating an evolutionary relationship between these two sequences, but rather is looking at the similarity or relatedness between their nucleic acid sequences. Many of the methods for determining homology between two evolutionarily related molecules are routinely applied to any two or more nucleic acids or proteins for the purpose of measuring sequence similarity regardless of whether they are evolutionarily related or not.

In general, it is understood that one way to define any known variants and derivatives or those that might arise, of the disclosed genes and proteins herein, is through defining the variants and derivatives in terms of homology to specific known sequences. This identity of particular sequences disclosed herein is also discussed elsewhere herein. In general, variants of genes and proteins herein disclosed typically have at least, about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 percent homology to the stated sequence or the native sequence. Those of skill in the art readily understand how to determine the homology of two proteins or nucleic acids, such as genes. For example, the homology can be calculated after aligning the two sequences so that the homology is at its highest level.

Another way of calculating homology can be performed by published algorithms. Optimal alignment of sequences for comparison may be conducted by the local homology algorithm of Smith and Waterman Adv. Appl. Math. 2: 482 (1981), by the homology alignment algorithm of Needleman and Wunsch, J. MoL Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989 which are herein incorporated by reference for at least material related to nucleic acid alignment. It is understood that any of the methods typically can be used and that in certain instances the results of these various methods may differ, but the skilled artisan understands if identity is found with at least one of these methods, the sequences would be said to have the stated identity, and be disclosed herein.

For example, as used herein, a sequence recited as having a particular percent homology to another sequence refers to sequences that have the recited homology as calculated by any one or more of the calculation methods described above. For example, a first sequence has 80 percent homology, as defined herein, to a second sequence if the first sequence is calculated to have 80 percent homology to the second sequence using the Zuker calculation method even if the first sequence does not have 80 percent homology to the second sequence as calculated by any of the other calculation methods. As another example, a first sequence has 80 percent homology, as defined herein, to a second sequence if the first sequence is calculated to have 80 percent homology to the second sequence using both the Zuker calculation method and the Pearson and Lipman calculation method even if the first sequence does not have 80 percent homology to the second sequence as calculated by the Smith and Waterman calculation method, the Needleman and Wunsch calculation method, the Jaeger calculation methods, or any of the other calculation methods. As yet another example, a first sequence has 80 percent homology, as defined herein, to a second sequence if the first sequence is calculated to have 80 percent homology to the second sequence using each of calculation methods (although, in practice, the different calculation methods will often result in different calculated homology percentages).

b) Hybridization/Selective Hybridization

The term hybridization typically means a sequence driven interaction between at least two nucleic acid molecules, such as a primer or a probe and a gene. Sequence driven interaction means an interaction that occurs between two nucleotides or nucleotide analogs or nucleotide derivatives in a nucleotide specific manner. For example, G interacting with C or A interacting with T are sequence driven interactions. Typically sequence driven interactions occur on the Watson-Crick face or Hoogsteen face of the nucleotide. The hybridization of two nucleic acids is affected by a number of conditions and parameters known to those of skill in the art. For example, the salt concentrations, pH, and temperature of the reaction all affect whether two nucleic acid molecules will hybridize.

Parameters for selective hybridization between two nucleic acid molecules are well known to those of skill in the art. For example, in some embodiments selective hybridization conditions can be defined as stringent hybridization conditions. For example, stringency of hybridization is controlled by both temperature and salt concentration of either or both of the hybridization and washing steps. For example, the conditions of hybridization to achieve selective hybridization may involve hybridization in high ionic strength solution (6×SSC or 6×SSPE) at a temperature that is about 12-25° C. below the Tm (the melting temperature at which half of the molecules dissociate from their hybridization partners) followed by washing at a combination of temperature and salt concentration chosen so that the washing temperature is about 5° C. to 20° C. below the Tm. The temperature and salt conditions are readily determined empirically in preliminary experiments in which samples of reference DNA immobilized on filters are hybridized to a labeled nucleic acid of interest and then washed under conditions of different stringencies. Hybridization temperatures are typically higher for DNA-RNA and RNA-RNA hybridizations. The conditions can be used as described above to achieve stringency, or as is known in the art. (Sambrook et al., Molecular Cloning: A Laboratory Manual, 2nd Ed., Cold Spring Harbor Laboratory, Cold Spring Harbor, N.Y., 1989; Kunkel et al. Methods Enzymol. 1987:154:367, 1987 which is herein incorporated by reference for material at least related to hybridization of nucleic acids). A preferable stringent hybridization condition for a DNA:DNA hybridization can be at about 68° C. (in aqueous solution) in 6×SSC or 6×SSPE followed by washing at 68° C. Stringency of hybridization and washing, if desired, can be reduced accordingly as the degree of complementarity desired is decreased, and further, depending upon the G-C or A-T richness of any area wherein variability is searched for. Likewise, stringency of hybridization and washing, if desired, can be increased accordingly as homology desired is increased, and further, depending upon the G-C or A-T richness of any area wherein high homology is desired, all as known in the art.

Another way to define selective hybridization is by looking at the amount (percentage) of one of the nucleic acids bound to the other nucleic acid. For example, in some embodiments selective hybridization conditions would be when at least about, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the limiting nucleic acid is bound to the non-limiting nucleic acid. Typically, the non-limiting primer is in for example, 10 or 100 or 1000 fold excess. This type of assay can be performed at under conditions where both the limiting and non-limiting primer are for example, 10 fold or 100 fold or 1000 fold below their k_{d}, or where only one of the nucleic acid molecules is 10 fold or 100 fold or 1000 fold or where one or both nucleic acid molecules are above their k_{d}.

Another way to define selective hybridization is by looking at the percentage of primer that gets enzymatically manipulated under conditions where hybridization is required to promote the desired enzymatic manipulation. For example, in some embodiments selective hybridization conditions would be when at least about, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the primer is enzymatically manipulated under conditions which promote the enzymatic manipulation, for example if the enzymatic manipulation is DNA extension, then selective hybridization conditions would be when at least about 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent of the primer molecules are extended. Preferred conditions also include those suggested by the manufacturer or indicated in the art as being appropriate for the enzyme performing the manipulation.

Just as with homology, it is understood that there are a variety of methods herein disclosed for determining the level of hybridization between two nucleic acid molecules. It is understood that these methods and conditions may provide different percentages of hybridization between two nucleic acid molecules, but unless otherwise indicated meeting the parameters of any of the methods would be sufficient. For example if 80% hybridization was required and as long as hybridization occurs within the required parameters in any one of these methods it is considered disclosed herein.

It is understood that those of skill in the art understand that if a composition or method meets any one of these criteria for determining hybridization either collectively or singly it is a composition or method that is disclosed herein.

c) Nucleic Acids

There are a variety of molecules disclosed herein that are nucleic acid based, including for example the nucleic acids that encode, for example, enzymes as well as any other proteins disclosed herein, as well as various functional nucleic acids. The disclosed nucleic acids are made up of for example, nucleotides, nucleotide analogs, or nucleotide substitutes. Non-limiting examples of these and other molecules are discussed herein. It is understood that, for example, when a vector is expressed in a cell, the expressed mRNA will typically be made up of A, C, G, and U. Likewise, it is understood that if, for example, an antisense molecule is introduced into a cell or cell environment through for example exogenous delivery it is advantageous that the antisense molecule be made up of nucleotide analogs that reduce the degradation of the antisense molecule in the cellular environment.

(1) Nucleotides and Related Molecules

A nucleotide is a molecule that contains a base moiety, a sugar moiety and a phosphate moiety. Nucleotides can be linked together through their phosphate moieties and sugar moieties creating an internucleoside linkage. The base moiety of a nucleotide can be adenin-9-yl (A), cytosin-1-yl (C), guanin-9-yl (G), uracil-1-yl (U), and thymin-1-yl (T). The sugar moiety of a nucleotide is a ribose or a deoxyribose. The phosphate moiety of a nucleotide is pentavalent phosphate. A non-limiting example of a nucleotide would be 3′-AMP (3′-adenosine monophosphate) or 5′-GMP (5′-guanosine monophosphate).

A nucleotide analog is a nucleotide which contains some type of modification to either the base, sugar, or phosphate moieties. Modifications to nucleotides are well known in the art and would include for example, 5-methylcytosine (5-me-C), 5-hydroxymethyl cytosine, xanthine, hypoxanthine, and 2-aminoadenine as well as modifications at the sugar or phosphate moieties.

Nucleotide substitutes are molecules having similar functional properties to nucleotides, but which do not contain a phosphate moiety, such as peptide nucleic acid (PNA). Nucleotide substitutes are molecules that will recognize nucleic acids in a Watson-Crick or Hoogsteen manner, but which are linked together through a moiety other than a phosphate moiety. Nucleotide substitutes are able to conform to a double helix type structure when interacting with the appropriate target nucleic acid.

It is also possible to link other types of molecules (conjugates) to nucleotides or nucleotide analogs to enhance for example, cellular uptake. Conjugates can be chemically linked to the nucleotide or nucleotide analogs. Such conjugates include but are not limited to lipid moieties such as a cholesterol moiety. (Letsinger et al., Proc. Natl. Acad. Sci. USA, 1989,86, 6553-6556),

A Watson-Crick interaction is at least one interaction with the Watson-Crick face of a nucleotide, nucleotide analog, or nucleotide substitute. The Watson-Crick face of a nucleotide, nucleotide analog, or nucleotide substitute includes the C2, N1, and C6 positions of a purine based nucleotide, nucleotide analog, or nucleotide substitute and the C2, N3, C4 positions of a pyrimidine based nucleotide, nucleotide analog, or nucleotide substitute.

A Hoogsteen interaction is the interaction that takes place on the Hoogsteen face of a nucleotide or nucleotide analog, which is exposed in the major groove of duplex DNA. The Hoogsteen face includes the N7 position and reactive groups (NH2 or O) at the C6 position of purine nucleotides.

(2) Sequences

There are a variety of sequences related to, for example, precursor enzymes disclosed herein, as well as any other protein disclosed herein that are disclosed on Genbank, and these sequences and others are herein incorporated by reference in their entireties as well as for individual subsequences contained therein.

A variety of sequences are provided herein and these and others can be found in Genbank, at www.pubmed.gov. Those of skill in the art understand how to resolve sequence discrepancies and differences and to adjust the compositions and methods relating to a particular sequence to other related sequences. Primers and/or probes can be designed for any sequence given the information disclosed herein and known in the art.

(3) Primers and Probes

Disclosed are compositions including primers and probes, which are capable of interacting with the genes disclosed herein. In certain embodiments the primers are used to support DNA amplification reactions. Typically the primers will be capable of being extended in a sequence specific manner. Extension of a primer in a sequence specific manner includes any methods wherein the sequence and/or composition of the nucleic acid molecule to which the primer is hybridized or otherwise associated directs or influences the composition or sequence of the product produced by the extension of the primer. Extension of the primer in a sequence specific manner therefore includes, but is not limited to, PCR, DNA sequencing, DNA extension, DNA polymerization, RNA transcription, or reverse transcription. Techniques and conditions that amplify the primer in a sequence specific manner are preferred. In certain embodiments the primers are used for the DNA amplification reactions, such as PCR or direct sequencing. It is understood that in certain embodiments the primers can also be extended using non-enzymatic techniques, where for example, the nucleotides or oligonucleotides used to extend the primer are modified such that they will chemically react to extend the primer in a sequence specific manner. Typically the disclosed primers hybridize with the nucleic acid or region of the nucleic acid or they hybridize with the complement of the nucleic acid or complement of a region of the nucleic acid.

d) Peptides

(1) Protein Variants

As discussed herein there are numerous variants of the precursor enzymes and proteins that are known and herein contemplated. In addition, to the known functional strain variants there are derivatives of the precursor enzymes and proteins which also function in the disclosed methods and compositions. Protein variants and derivatives are well understood to those of skill in the art and in can involve amino acid sequence modifications. For example, amino acid sequence modifications typically fall into one or more of three classes: substitutional, insertional or deletional variants. Insertions include amino and/or carboxyl terminal fusions as well as intrasequence insertions of single or multiple amino acid residues. Insertions ordinarily will be smaller insertions than those of amino or carboxyl terminal fusions, for example, on the order of one to four residues. Immunogenic fusion protein derivatives, such as those described in the examples, are made by fusing a polypeptide sufficiently large to confer immunogenicity to the target sequence by cross-linking in vitro or by recombinant cell culture transformed with DNA encoding the fusion. Deletions are characterized by the removal of one or more amino acid residues from the protein sequence. Typically, no more than about from 2 to 6 residues are deleted at any one site within the protein molecule. These variants ordinarily are prepared by site specific mutagenesis of nucleotides in the DNA encoding the protein, thereby producing DNA encoding the variant, and thereafter expressing the DNA in recombinant cell culture. Techniques for making substitution mutations at predetermined sites in DNA having a known sequence are well known, for example M13 primer mutagenesis and PCR mutagenesis. Amino acid substitutions are typically of single residues, but can occur at a number of different locations at once; insertions usually will be on the order of about from 1 to 10 amino acid residues; and deletions will range about from 1 to 30 residues. Deletions or insertions preferably are made in adjacent pairs, i.e. a deletion of 2 residues or insertion of 2 residues. Substitutions, deletions, insertions or any combination thereof may be combined to arrive at a final construct. The mutations must not place the sequence out of reading frame and preferably will not create complementary regions that could produce secondary mRNA structure. Substitutional variants are those in which at least one residue has been removed and a different residue inserted in its place. Such substitutions generally are made in accordance with the following Tables 2 and 3 and are referred to as conservative substitutions.

TABLE 2
Amino Acid Abbreviations

| Amino Acid | Abbreviations |
|---|---|
| alanine | Ala (A) |
| alloisoleucine | AIle |
| arginine | Arg (R) |
| asparagine | Asn (N) |
| aspartic acid | Asp (D) |
| cysteine | Cys (C) |
| glutamic acid | Glu (E) |
| glutamine | Gln (Q) |
| glycine | Gly (G) |
| histidine | His (H) |
| isolelucine | Ile (I) |
| leucine | Leu (L) |
| lysine | Lys (K) |
| phenylalanine | Phe (F) |
| proline | Pro (P) |
| pyroglutamic acid | Glu |
| serine | Ser (S) |
| threonine | Thr (T) |
| tyrosine | Tyr(Y) |
| tryptophan | Trp (W) |
| valine | Val (V) |

TABLE 3
Amino Acid Substitutions
Original Residue Exemplary Conservative
Substitutions, others are known in the art.

Ala [symbol] ser
Arg [symbol] lys or gln
Asn [symbol] gln or his
Asp [symbol] glu
Cys [symbol] ser
Gln [symbol] asn or lys
Glu [symbol] asp
Gly [symbol] pro
His [symbol] asn or gln
Ile [symbol] leu or val
Leu [symbol] ile or val
Lys [symbol] arg or gln;
Met [symbol] Leu or ile
Phemet [symbol] leu or tyr
Ser [symbol] thr
Thr [symbol] ser
Trp [symbol] tyr
Tyr [symbol] trp or phe
Val [symbol] ile or leu

Substantial changes in function or immunological identity are made by selecting substitutions that are less conservative than those in Table 3, i.e., selecting residues that differ more significantly in their effect on maintaining (a) the structure of the polypeptide backbone in the area of the substitution, for example as a sheet or helical conformation, (b) the charge or hydrophobicity of the molecule at the target site or (c) the bulk of the side chain. The substitutions which in general are expected to produce the greatest changes in the protein properties will be those in which (a) a hydrophilic residue, e.g. seryl or threonyl, is substituted for (or by) a hydrophobic residue, e.g. leucyl, isoleucyl, phenylalanyl, valyl or alanyl; (b) a cysteine or proline is substituted for (or by) any other residue; (c) a residue having an electropositive side chain, e.g., lysyl, arginyl, or histidyl, is substituted for (or by) an electronegative residue, e.g., glutamyl or aspartyl; or (d) a residue having a bulky side chain, e.g., phenylalanine, is substituted for (or by) one not having a side chain, e.g., glycine, in this case, (e) by increasing the number of sites for sulfation and/or glycosylation.

For example, the replacement of one amino acid residue with another that is biologically and/or chemically similar is known to those skilled in the art as a conservative substitution. For example, a conservative substitution would be replacing one hydrophobic residue for another, or one polar residue for another. The substitutions include combinations such as, for example, Gly, Ala; Val, Ile, Leu; Asp, Glu; Asn, Gln; Ser, Thr; Lys, Arg; and Phe, Tyr. Such conservatively substituted variations of each explicitly disclosed sequence are included within the mosaic polypeptides provided herein.

Substitutional or deletional mutagenesis can be employed to insert sites for N-glycosylation (Asn-X-Thr/Ser) or O-glycosylation (Ser or Thr). Deletions of cysteine or other labile residues also may be desirable. Deletions or substitutions of potential proteolysis sites, e.g., Arg, is accomplished for example by deleting one of the basic residues or substituting one by glutaminyl or histidyl residues.

Certain post-translational derivatizations are the result of the action of recombinant host cells on the expressed polypeptide. Glutamninyl and asparaginyl residues are frequently post-translationally deamidated to the corresponding glutamyl and asparyl residues. Alternatively, these residues are deamidated under mildly acidic conditions. Other post-translational modifications include hydroxylation of proline and lysine, phosphorylation of hydroxyl groups of seryl or threonyl residues, methylation of the o-amino groups of lysine, arginine, and histidine side chains (T. E. Creighton, Proteins: Structure and Molecular Properties, W. H. Freeman & Co., San Francisco pp 79-86 [1983]), acetylation of the N-terminal amine and, in some instances, amidation of the C-terminal carboxyl.

It is understood that one way to define the variants and derivatives of the disclosed proteins herein is through defining the variants and derivatives in terms of homology/identity to specific known sequences. Specifically disclosed are variants of these and other proteins herein disclosed which have at least, 70% or 75% or 80% or 85% or 90% or 95% homology to the stated sequence. Those of skill in the art readily understand how to determine the homology of two proteins. For example, the homology can be calculated after aligning the two sequences so that the homology is at its highest level.

Another way of calculating homology can be performed by published algorithms. Optimal alignment of sequences for comparison may be conducted by the local homology algorithm of Smith and Waterman Adv. Appl. Math. 2: 482 (1981), by the homology alignment algorithm of Needleman and Wunsch, J. MoL Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989 which are herein incorporated by reference for at least material related to nucleic acid alignment.

It is understood that the description of conservative mutations and homology can be combined together in any combination, such as embodiments that have at least 70% homology to a particular sequence wherein the variants are conservative mutations.

As this specification discusses various proteins and protein sequences it is understood that the nucleic acids that can encode those protein sequences are also disclosed. This would include all degenerate sequences related to a specific protein sequence, i.e. all nucleic acids having a sequence that encodes one particular protein sequence as well as all nucleic acids, including degenerate nucleic acids, encoding the disclosed variants and derivatives of the protein sequences. Thus, while each particular nucleic acid sequence may not be written out herein, it is understood that each and every sequence is in fact disclosed and described herein through the disclosed protein sequence. It is also understood that while no amino acid sequence indicates what particular DNA sequence encodes that protein within an organism, where particular variants of a disclosed protein are disclosed herein, the known nucleic acid sequence that encodes that protein in the particular organism from which that protein arises is also known and herein disclosed and described.

It is understood that there are numerous amino acid and peptide analogs which can be incorporated into the disclosed compositions. For example, there are numerous D amino acids or amino acids which have a different functional substituent then the amino acids shown in Table 2 and Table 3. The opposite stereo isomers of naturally occurring peptides are disclosed, as well as the stereo isomers of peptide analogs. These amino acids can readily be incorporated into polypeptide chains by charging tRNA molecules with the amino acid of choice and engineering genetic constructs that utilize, for example, amber codons, to insert the analog amino acid into a peptide chain in a site specific way (Thorson et al., Methods in Molec. Biol. 77:43-73 (1991), Zoller, Current Opinion in Biotechnology, 3:348-354 (1992); Ibba, Biotechnology & Genetic Enginerring Reviews 13:197-216 (1995), Cahill et al., TIBS, 14(10):400-403 (1989); Benner, TIB Tech, 12:158-163 (1994); Ibba and Hennecke, Bio/technology, 12:678-682 (1994) all of which are herein incorporated by reference at least for material related to amino acid analogs).

Molecules can be produced that resemble peptides, but which are not connected via a natural peptide linkage. For example, linkages for amino acids or amino acid analogs can include CH₂NH—, —CH₂S—, —CH₂—CH₂—, —CH═CH— (cis and trans), —COCH₂—, —CH(OH)CH₂—, and —CHH₂SO—(These and others can be found in Spatola, A. F. in Chemistry and Biochemistry of Amino Acids, Peptides, and Proteins, B. Weinstein, eds., Marcel Dekker, New York, p. 267 (1983); Spatola, A. F., Vega Data (March 1983), Vol. 1, Issue 3, Peptide Backbone Modifications (general review); Morley, Trends Pharm Sci (1980) pp. 463-468; Hudson, D. et al., Int J Pept Prot Res 14:177-185 (1979) (—CH₂NH—, CH₂CH₂—); Spatola et al. Life Sci 38:1243-1249 (1986) (—CH H₂—S); Hann J. Chem. Soc Perkin Trans. I 307-314 (1982) (—CH—CH—, cis and trans); Almquist et al. J. Med. Chem. 23:1392-1398 (1980) (—COCH₂—); Jennings-White et al. Tetrahedron Lett 23:2533 (1982) (—COCH₂—); Szelke et al. European Appln, EP 45665 CA (1982): 97:39405 (1982) (—CH(OH)CH₂—); Holladay et al. Tetrahedron. Lett 24:4401-4404 (1983) (—C(OH)CH₂—); and Hruby Life Sci 31:189-199 (1982) (—CH₂—S—); each of which is incorporated herein by reference. A particularly preferred non-peptide linkage is —CH₂NH—. It is understood that peptide analogs can have more than one atom between the bond atoms, such as b-alanine, g-aminobutyric acid, and the like.

Amino acid analogs and analogs and peptide analogs often have enhanced or desirable properties, such as, more economical production, greater chemical stability, enhanced pharmacological properties (half-life, absorption, potency, efficacy, etc.), altered specificity (e.g., a broad-spectrum of biological activities), reduced antigenicity, and others.

D-amino acids can be used to generate more stable peptides, because D amino acids are not recognized by peptidases and such. Systematic substitution of one or more amino acids of a consensus sequence with a D-amino acid of the same type (e.g., D-lysine in place of L-lysine) can be used to generate more stable peptides. Cysteine residues can be used to cyclize or attach two or more peptides together. This can be beneficial to constrain peptides into particular conformations. (Rizo and Gierasch Ann. Rev. Biochem. 61:387 (1992), incorporated herein by reference).

### VII. EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of conditions, e.g., component concentrations, desired solvents, solvent mixtures, temperatures, pressures and other reaction ranges and conditions that can be used to optimize the methods described herein. Only reasonable and routine experimentation will be required to optimize such process conditions.

### 1. Example 1

### Nucleoside Analog Production

Nucleoside analogs were chosen as targets for bioretrosynthesis. In addition to their clinical importance, these compounds are structurally related to natural products in primary metabolism and do not require many steps in their biosynthesis. Furthermore, nucleoside analogs are well represented in the pantheon of known secondary metabolites. Aristeromycin (Jenkins, G. N., and Turner, N. J., 1995, The Biosynthesis of Carbocyclic Nucleosides, Chem. Soc. Rev. 24:169-176; Hill, J. M., et al., 1995, Revised Pathway for the Biosynthesis of Aristeromycin and Neplanocin a from D-Glucose in Streptomyces Citricolor, J. Am. Chem. Soc. 117:5391-5392; Parry, R. J., and Jiang, Y. J., 1995, The Biosynthesis of Aristeromycin, Conversion of Neplanocin-a to Aristeromycin by a Novel Enzymatic Reduction, Abst. Papers Am. Chem. Soc. 210:199-Orgn), tubercidin (Mooberry, S. L., et al., 1995, Tubercidin stabilizes microtubules against vinblastine-induced depolymerization, a taxol-like effect. Cancer Lett. 96:261-266), AT-265 (Takahashi, E., and Beppu, T., 1982. A new nucleosidic antibiotic AT-265. J. Antibiot. (Tokyo) 35:939-947) and showdomycin (Isono, K., et al., 1984, Ascamycin and dealanylascamycin, nucleoside antibiotics from Streptomyces sp, J. Antibiot. (Tokyo) 37:670-672) are a few examples shown below. However, little is known about their genetics and pathway biochemistry. The bioretrosynthetic approach can yield insight into how these molecules are synthesized in nature.

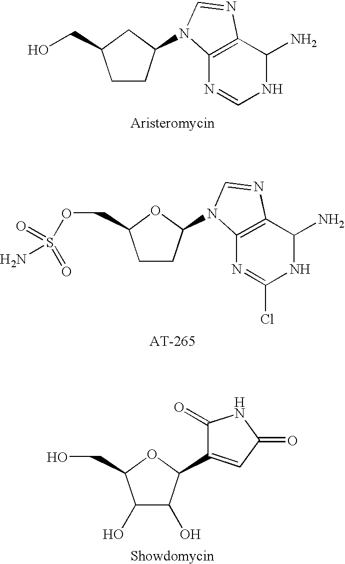

Viral infections, including HIV, hepatitis B (HBV), herpes, and SARS, constitute some of the most serious threats to human health. Nucleoside analogs were some of the first compounds known to possess antiviral activity and are key agents in the palette of drugs used to treat viral infections today. Action of nucleoside analogs is preceded by intracellular triphosphorylation by native kinases. These drugs compete with natural nucleosides triphosphates for viral reverse transcriptase and/or DNA polymerases.

Many nucleoside analogs, including dideoxyinosine (ddI, VIDEX™), are broadly prescribed as HIV reverse transcriptase inhibitors, and are generally prescribed as a component of a combination therapy that includes protease inhibitors. These drug “cocktails” are an essential component of AIDS treatment, providing substantial suppression of viral loads in infected individuals. The primary disadvantages of nucleoside analogs are their toxicity, lack of activity in selected cell types, and susceptibility to viral drug resistance. Consequently, the chemical synthesis of both new and existing nucleoside analogs remains an active area of research. Nucleoside analogs with lower toxicity and reduced susceptibility to resistance would have a significant effect on world health.

Currently, dideoxynucleosides are prepared synthetically by a number of routes (Vorbruggen, and Ruh-Polenz. 2001. Handbook of Nucleoside Synthesis. Wiley, New York; Huryn, D. M., and Okabe, M., 1992. Aids-Driven Nucleoside Chemistry. Chemical Reviews 92:1745-1768). Some biocatalytic methods have also been attempted including pyrimidine-purine interconversion for dideoxypyrimidines in resting cells of E. coli. Ultimately, these pathways involve costly multi-step chemical syntheses. The bioretrosynthetic methods disclosed herein, however, offer a “green” (i.e., environmentally friendly) alternative to chemical synthesis of nucleoside analogs.

A biosynthetic scheme for the production of dideoxyinosine in E. coli is shown in Scheme 1. In Scheme 1, HPRT is hypoxanthine phosphoribosyltransferase, PPRPS is phosphoribosylpyrophosphate synthase, and RK is ribokinase, which are evolved retroconsecutively, selecting for product ddIMP, 4.

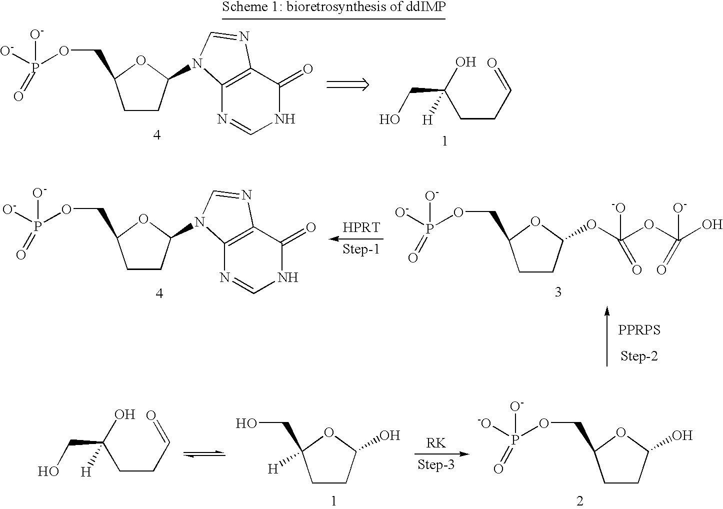

The purine salvage enzyme hypoxanthine phosphoribosyl-transferase can be recruited first and evolved to convert dideoxyphosphoribosylpyrophosphate (ddPRPP, 3) to dideoxyinosine phosphate (ddIMP, 4). Subsequently, the enzyme phosphoribosylpyrophosphate synthetase, can be recruited and evolved to synthesize dideoxyribose phosphate, the next to last precursor in the pathway (this would correspond to compound “D” in FIG. 1). This gene can be evolved in the presence of previously optimized HPRT and a product-based or ultimate activity assay can be used to detect turnover. The process can be iterated with evolution of ribokinase (RK) to phosphorylate dideoxyribose (ddR, 1) to dideoxyribose-5-phosphate (ddR-5P 2), in the presence of PRPTS and HPRT. At this point, a three-step pathway for converting dideoxyribose to dideoxinosine phosphate is generated. An advantage of retroconsecutive assembly is that only a single sensitive assay is needed to evolve all three enzymes in the pathway.

To obviate possible complications of executing this scheme in E. Coli, such as toxicity of ddIMP to E. coli, unknown metabolite transport phenomenon, and regulation issues, overexpressed cell free extracts can be used. Multiple steps can be optimized retroconsecutively in cell-free extracts. Cell-free systems have been used to catalyze multiple transformations. For instance, up to 20 contiguous transformations have been utilized in cell-free aflatoxin biosynthesis (Watanabe, C. M. H., and Townsend, C. A., 1998, The in vitro conversion of norsolorinic acid to aflatoxin B-1. An improved method of cell-free enzyme preparation and stabilization, J. Am. Chem. Soc. 120:6231-6239).

a) Synthesis of Intermediates

Prior to retro-evolution, the biosynthetic intermediates were obtained. Scheme 2 shows the synthetic route used to obtain these intermediates. Specifically, commercially available lactone (6) was phosphorylated with diisopropylamino dibenzyl phosphor-amidite. The lactone was then selectively reduced with DIBAL-H, resulting in lactol (7). Lactone (6) was also directly reduced with DIBAL-H without protection to yield lactol (1).

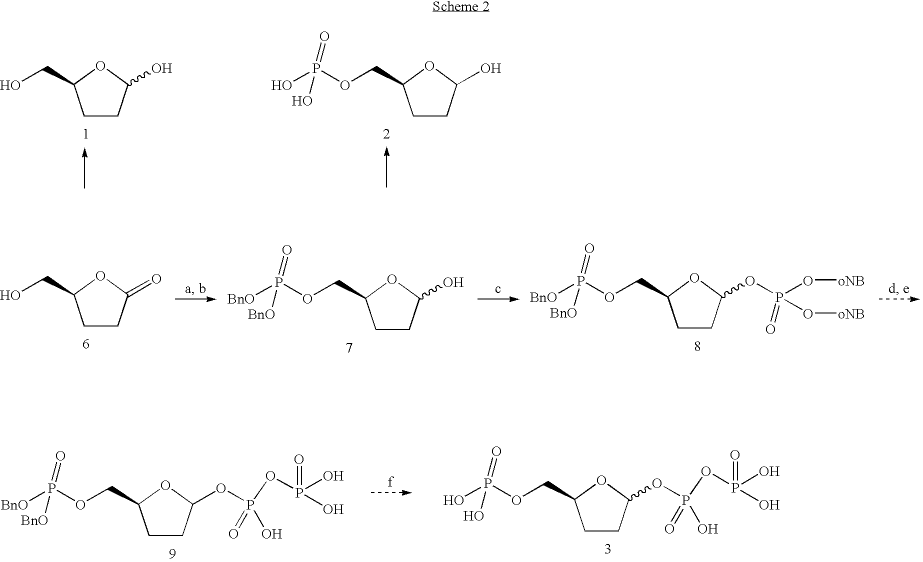

Synthesis of bioretrosynthetic intermediates. (a) (iPr)₂NP(OBn)₂, tetrazole 60-70%; (b) DIBALH −78° C. 60-80%; (c) (iPr)₂NP(OtBu)₂, tetrazole ˜50%; (d) TFA/CH₂Cl₂; (e) CDI, (Et₃N)₃H₃PO₃; (f) H₂, Pd/C.

Lactol (7) was phosphorylated with an orthogonally protective group, o-nitrobenzyl phosphoramidite to yield compound (8) in accordance with literature precedent (Lazarevic, D., and Thiem, J., 2002, Syntheses of unnatural N-substituted UDP-galactosamines as alternative substrates for N-acetylgalactosaminyl transferases, Carbohydrate Res. 337:2187-2194). Selective deprotection resulted in 1′-monophosphate which was condensed with carbodiimide and deprotected to yield compound (3) (Kim, H. S., et al., 2001, Acyclic and cyclopropyl analogues of adenosine bisphosphate antagonists of the P2Y(1) receptor: Structure-activity relationships and receptor docking, J. Med. Chem. 44:3092-3108). All compounds were characterized by ¹H and ¹³C NMR and mass spectrometry. Anomeric diastereomers were separable by traditional chromatographic techniques. Dideoxyribose-5-phosphate (2) is obtained by catalytic hydrogenation of 7.

b) Identification and Expression of Pathway Progenitors in E coli.

The progenitor biosynthetic genes, HPRT, PPRPS, and RK were amplified from purified DH5α E. coli genomic DNA with flanking restriction sites by PCR, and initially cloned into pET28a expression vectors. The PCR primers used are detailed below.

HPRTK12F: 5′ GAATTCCATATG ATGAAACATACTGTAGAAG 3′ (SEQ ID NO:1)

KPRTK12R: 5′ GAATTCAAGCTT TTACTCGTCCAGCAGAATC 3′ (SEQ ID NO:2)

PPRPSK12F: 5′ GAATTCCATATG GTGCCTGATATGAAGC 3′ (SEQ ID NO:3)

PPRPSK12R: 5′ GAATTCCTCGAG TTAGTGTFCGAACATG 3′ (SEQ ID NO:4)

RKK12F: 5′ GAATTCGGATCCATGCAAAACGCAGGC 3′ (SEQ ID NO:5)

RKK12R: 5′ GAATTCGTCGAC TCACCTCTGCCTGTCT 3′ (SEQ ID NO:6)

The HPRT and PPRPS PCR products were digested and cloned into pET28a, an IPTG inducible T7-based expression system under the control of the lac operator. Gene sequences were cloned into restriction sites in pET28a so that they are in-frame with an N-terminal His-tag sequence in order to facilitate purification. Expression of proteins was assayed by SDS-PAGE electrophoresis as shown in FIG. 5.

c) Construction of Overexpression Systems in E. coli

PPRPS was subcloned into the DUET™ vector pACYC vector, which is compatible for co-overexpression with pET28a. pACYC has a unique origin of replication and antibiotic resistance marker that facilitate co-overexpression. pET28-HPRT and PPRPS-pACYC were transformed into chemically competent BL21DE3, which is optimized for IPTG induced overexpression of both vectors. HPRT and PPRPS co-overexpression was verified by SDS-PAGE gel electrophoresis, and enzymatic activity was confirmed. Though the majority of PPRPS was observed as insoluble protein, a substantial amount of protein was soluble. This was confirmed by nickel affinity (Ni—NTA) purification of soluble His-tagged PPRPS, and activity assays from PPRPS-pACYC transformants.

d) Reaction Screening Assay Development

Several assay methodologies for detecting product, or ultimate enzyme activity in the bioretrosynthesis of dideoxyinosine are described below. One assay for ultimate (HPRT) activity is to measure the depletion of hypoxanthine in the presence of ribosyl substrates. This approach has the advantage of being tunable to various levels of sensitivity, depending on how much reaction is observed in basal cases. As shown in FIG. 7 (left panel), conversion of hypoxanthine to inosine was measured directly at 245 nm, with a reported difference in extinction coefficient of 1900 M⁻¹ cm⁻¹. More sensitive measurements of hypoxanthine consumption can be followed by adding xanthine oxidase after thermal inactivation. Xanthine oxidase converts remaining hypoxanthine to uric acid (ε=5900 M⁻¹) generating hydrogen peroxide in the process. If even greater sensitivity is required, horseradish peroxidase and 10H-phenoxazine-3,7-diol (AMPLEX RED™, Molecular Probes, Inc., Eugene, Oreg.) can be added to detect generated hydroperoxide. AMPLEX RED is oxidized to resorufin (ε=23000 M⁻¹), which can be detected with even greater sensitivity by fluorescence. FIG. 7 (right panel) shows saturation kinetics of HPRT (versus PPRP) via 96-well assay of an overexpressed HPRT clone.

These assays were optimized for HPRT activity detection in cell-free extracts from E. coli containing recombinant overexpressed HPRT in 96 well plate format. As shown in FIG. 8, cells (200 μL) were disrupted by adding 22 μL 10× BUGBUSTER™ detergent (Novagen), and incubating at 25° C. for 30 minutes. In reactions containing 25 μL of this cell-free extract, 100 μM hypoxanthine, 1 mM PPRP and 5 mM MgCl₂, it was possible to detect complete depletion of hypoxanthine. Dilution studies employing as little as 0.4 μL of “1×” cell free extract containing overexpressed HPRT, demonstrated substantial conversion. A control consisting of E. coli containing pET28a plasmid only showed undetectable hypoxanthine consumption with up to 25 μL at 30 minutes. FIG. 7, shows saturation kinetics employing the assay. It was estimated that less than 0.2 μM hypoxanthine consumption (0.2% reaction) can be reliably detected using absorption measurements and, if greater sensitivity is required, gain an order of magnitude with fluorescence methods. This assay was performed in a SPECTRAMAX 96/384-well plate reader.

e) Assayed Activities of Overexpressed Enzymes in Tandem

In the bioretrosynthetic methods disclosed herein, the assay for the last step in the biosynthesis (hypoxanthine depletion, for instance; or the first iteration in FIG. 1) can be employed to detect tandem conversion in the pathway. The dual overexpressed pET28-HPRT/pACYC-PPRPS cell free extract was assayed first for the conversion of PPRP to IMP, via hypoxanthine consumption as shown in FIG. 9. Michealis kinetics was observed in 96-well plate format for varying PPRP concentrations. The cell-free extract was then used to assay for the tandem conversion of ribose-5-phosphate to IMP in the presence of ATP (3 mM) and hypoxanthine (100 μM), and phosphate (5 mM). A 1-hour tandem reaction demonstrated ample observable consumption of hypoxanthine. Though hypoxanthine consumption was substantially lower in these non-optimized tandem reactions, ribose-5-phosphate concentration dependent kinetics were easily detectable. Assay optimization should improve turnover substantially.

f) Mutagenesis/Screening

There are many means to introduce diversity into gene libraries for directed evolution. A facile method is error prone PCR in which Taq polymerase, in the presence of elevated Mg concentrations, inclusion of Mn, and other factors can tune the mutation rate from about 0.11 to about 2%. (Cirino, P. C., et al., 2003, Generating Mutant Libraries Using Error Prone PCR, Methods Mol. Biol. 231:3-9). Other than the inclusion of additives, these methods are identical to PCR cloning described above. To enhance PCR product restriction efficiency, primers were designed to amplify the genes from pET28-HPRT constructs, which locate cloning restriction sites over 20 base pairs from product termini. Transformation into Electromax DH10β cells by electroporation yielded a large number of transformants. High colony-density transformants were washed from plates and plasmid DNA isolated to generate the diverse plasmid library. This library was transformed into chemically competent BL21(DE3) cells. Ten clones containing insert were picked for sequencing, T7 terminator primers were used for end-sequencing reactions demonstrating a mutation rate of approximately 2/1000 bp. A pilot screening attempt using the sub-cloned mutagenic PCR library is shown in FIG. 10. Activity assays for 40 clones of “wild-type” and mutant HPRT demonstrate the reproducibility of the hypoxanthine consumption assay and, indirectly, the mutation rate. The fraction of “dead” mutant is about 5%, which is consistent with the sequencing results. Typically a dead mutant rate of about 30 to about 40% has been reported in successiful directed evolution experiments.

### 2. Example 2

In the present example, the biosynthetic intermediates are analogs of main arteries in primary metabolism and they can find uses in other research as enzyme inhibitors or substrate analogs for structural and metabolic studies.

Disclosed herein are synthetic methods for 5-phosphorylation and synthesis of dideoxyribose and dideoxyribose-5-phoshphate. As pyrophosphate is the least stable moiety in dideoxyphosphoribosyl pyrophosphate (PPRP), this functionality was introduced at a late stage in the synthesis. Two general synthetic strategies are possible for pyrophosphorylation at the 1-position in which protected ribose-phosphate is either activated to create an electrophile, or serves as a nucleophile for an activated phosphorus reagent.

There are no reported methods for direct 1-pyrophosphorylation (pathway B, Scheme 3) of pentose and furanose derivatives. There are, however, 1-phoshorylation methods in which ribosides are activated as bromides (Arlt, M., and Hindsgaul, O., 1995, Rapid Chemical Synthesis of Sugar Nucleotides in a Form Suitable for Enzymatic Oligosaccharide Synthesis, J. Org. Chem. 60:14-15), or triflates (Garcia, B. A., and Gin, D. Y., 2000, Synthesis of glycosyl-1-phosphates via dehydrative glycosylation, Org. Lett. 2:2135-2138; Garcia, B. A., and Gin, D. Y., 2000, Dehydrative glycosylation with activated diphenyl sulfonium reagents. Scope, mode of C(1)-hemiacetal activation, and detection of reactive glycosyl intermediates, J. Am. Chem. Soc. 122:4269-4279; via a sulfoxide). These methods did not meet with success for 5-phosphate containing molecules. As a result, efforts focused on phosphorylation via pathway A (Scheme 3), for which there is abundant literature precedent. 1-phosphorylation of sugars has been used to synthesize activated glycosyl doners for polysaccharide synthesis via standard phosphoramidite methodologies. Deprotected 1-phosphates have then been activated and phosphorylated to produce 1-pyrophosphates.

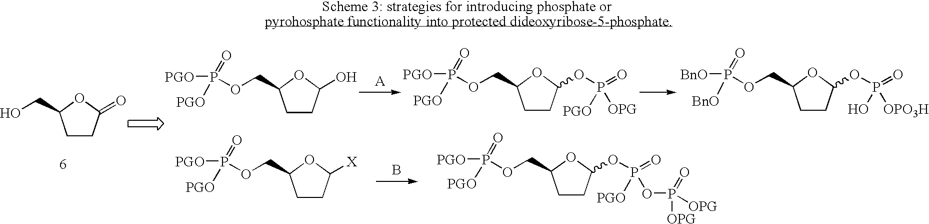

Ultimately, the α-anomer of ddPPRP was desired. Diastereomeric 1,5-bisphosphates are reported to be separable chromatographically. Anomeric stereochemistry is generally not a concern for the biosynthetic intermediates PddR and ddR, due to rapid interconversion under physiological conditions.

a) Chemical Synthesis of Biosynthetic Intermediates for Dideoxyinosine

A synthetic route to 5-benzyl dideoxyribose from γ-lactone 6 has been successfully implemented, as described herein. Other syntheses can employ o-nitrobenzyl protected phosphor-amidite, which is easily synthesized and reportedly can be selectively cleaved in the presence of additional benzyl functionality (Takaoka, K., et al., 2003, Synthesis and photoreactivity of caged blockers for glutamate transporters, Bioorg. & Med. Chem. Lett. 13:965-970) by ultraviolet radiation. The labile nature of the anomeric phosphate under deptrotection conditions can be a concern.

Alternatively, (as shown in Scheme 4) a 4,5-dimethoxy-2-nitrobenzyl substituted phosphoramidite, which can be selectively photocleaved under very mild conditions, can be employed (Givens, R. S., and L. W. Kueper, 1993, Photochemistry of Phosphate-Esters, Chemical Reviews 93:55-66). Carbodiimide activations of 1-phosphates 13 to accept phosphates as a nucleophile are well precedented (Kim, H. S., et al., 2001, Acyclic and cyclopropyl analogues of adenosine bisphosphate antagonists of the P2Y(1) receptor: Structure-activity relationships and receptor docking, J. Med. Chem. 44:3092-3108; Ye, X. Y., et al., 2001, Better substrates for bacterial transglycosylases, J. Am. Chem. Soc. 123:3155-3156) (Scheme 5).

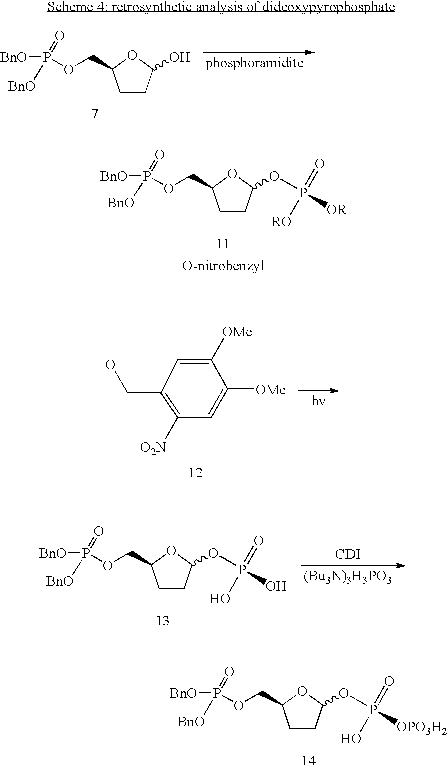

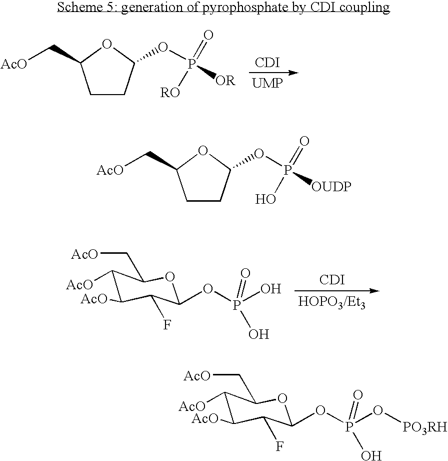

b) Identification and Expression of Pathway Progenitor Enzymes in E. coli.

Heterologously expressed enzymes with basal or better activity for the desired chemistry can be used for directed evolution experiments. For the three step ddIMP pathway, three primary metabolic genes with soluble active expression in E. coli can be cloned.

E. coli was chosen as a source of biosynthetic gene sequence due to commercially available and widely used expression systems (pET) and the large amount of sequence, structural, and activity data within this species. The three enzyme hypoxanthine phosphoribosyl transferase (HPRT), PRPP synthetase (PRPPS) and ribokinase (RK) can be cloned via PCR methods into His-tagged expression vectors based on pET28a. Protein expression, solubility and activity can be evaluated in this system. The sequences can then be cloned into Duet expression vectors (Novagen, San Diego, Calif.) which are optimized for simultaneous expression of up to eight proteins in a single organism. The experimental design permits optimization of individual enzyme activities in a reverse stepwise fashion.

(1) Structure Analysis and Selection of Progenitor Enzymes

Enzymes to be used as effective starting points for directed evolution of new activity can be identified. Biosynthetic disconnections using enzymes that have structural data as candidates for preliminary evaluation in silico can be used for the identification.

Hypoxanthine phosphoribosylphosphate transferase (HPRT), phosphoribosyl pyrophosphate synthetase, (PRPPS) and ribokinase (RK) were identified as primary recruitment candidates for pathway engineering. The corresponding structures were analyzed to determine if proposed substrate analogs presented identifiable challenges to active site geometry and catalysis. The proposed substrates are all 2,3-dideoxy analogs of corresponding ribose substrates. In that these analogs have the same charge, and occupy less space than the natural substrates, they are good candidates for alternate substrates.

In the case of HPRT (FIG. 11), which orients hypoxanthine for nucleophillic displacement of pyrophosphate, the dominant interactions are with the strong charge anchors of the phosphate and pyrophosphate groups. The 5-phosphate of the substrate is bound in an oxo-anion hole environment of back-bone amides and a Ser-108 hydroxyl. The hypoxanthine and pyrophosphate interactions are also predicted to be mainly unperturbed. Some bonding interaction is seen between the active site magnesium and the ribose hydroxyls. However, these interactions can be substituted by a water molecule in the evolved active site containing the dideoxy analog. X-ray structures of HPRT with IMP demonstrate that most substrate-enzyme interactions are preserved in the absence of Mg²⁺/PPᵢ (FIG. 11). In addition to this structural data, kinetic data provides that magnesium binds to the apo enzyme before PRPP and leaves with pyrophosphate before inosine. This is additional evidence that the 2- and 3-hydroxyls of PRPP are not essential binding elements for catalysis.

A similar case occurs for PPRP synthetase, an enzyme that catalyzes the addition of the 1-hydroxyl of ribose-5-phosphate to the β-phosphate of ATP, releasing adenosine monophosphate. Unlike HPRT, PPRP synthetase has an absolute requirement for phosphate ion (Pᵢ) in addition to magnesium ions. Though no structure exists with bound ribose-5-phosphate, PPRP synthetase shares the same fold as type-I phoshoribosyltransferases, suggesting that ribose-5-phosphate binds in a flexible loop region of the protein, in a similar fashion as it does in HPRT (FIG. 11). Additionally, steady state kinetics indicate that magnesium binds to the apo enzyme before ribose-5-phosphate, implying that magnesium-2′-3′-hydroxyl interactions are not essential for catalytic magnesium binding. The apo and ATP-bound structures and kinetics also demonstrate independence of MgATP binding on PRPP. These data, combined with the smaller steric size of dideoxyribose phosphate make it a suitable substrate for PRPP synthetase and disclosed directed evolution experiments.

Predicting substrate fitness of didexoyribose for ribokinase is shown in FIG. 12. Analysis of the active site indicates an Asp-16 interacting with the 2′ and 3′-hydroxyls of ribose. Though other interactions outnumber these and are predicted to be conserved, including those of ATP and the 1,5-hydroxyls, the disruption of this N-terminal Asp-16 can have consequences for catalysis. In the event that Asp-16 interactions dominate catalysis, an alternative would be to work with deoxyribokinase or phosphopentomutase (Scheme 6), which is known competently process dideoxyribose (Hamamoto, T., 1998. Phosphopentomutase of Bacillus stearothermophilus TH6-2: The enzyme and its gene ppm. Biosci. Biotechnol. Biochem. 62:1103-1108).

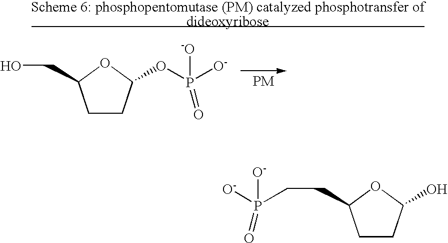

(2) Cloning of Biocatalytic Enzymes

The amplification of HPRT, PPRPS, and RK genes, performed as per standard PCR methods, is described above. Synthetic oligodeoxynucleotides primers include introduce restriction sites appropriate for cloning into expression vectors pET28a and pACYCD as shown in FIG. 15. pET28a (Novagen) can be used for initial directed evolution experiments involving HPRT and ddPPRP. pACYCD (Novagen) can be used as a dual expression system for PPRPS and RK (see section c below.)

(3) Soluble Expression of Biocatalytic Enzymes

Protein expression is induced by addition of IPTG to the cells at log-phase. Expression and solubility can be assayed by standard methodologies by PAGE analysis of cell-free extract and pellet. Initially, each enzyme can be cloned into pET28a and expressed as a histidine tagged protein and purified by nickel-agarose chromatography. Subsequent to confirmation of activity, PPRPS and RK genes can be subcloned into the Duet vector, as described, and similarly assayed for soluble proteins. Activity assays can be used to confirm all enzyme activities with natural and unnatural substrates.

(4) Activity Assays

Activity assays for HPRT, PPRPS, and RK can be performed in order to verify that the enzymes are expressed in an active form and to assay the turnovers for the synthetic substrates in comparison to the natural substrates. HPRT activity assay is described above. Assays for ribokinase and phosphoribosylpyrophophate synthetase are based on the general scheme shown in Scheme 7. For PPRPS, AMP can be detected by adaptation of a standard assay for AMP blood plasma determination. A tandem assay using myokinase, PEP kinase, and lactic dehydrogenase provides reliable determination of AMP as a change in absorbance at 340 nm. To assay for ADP formation, myokinase can be omitted from the assay.

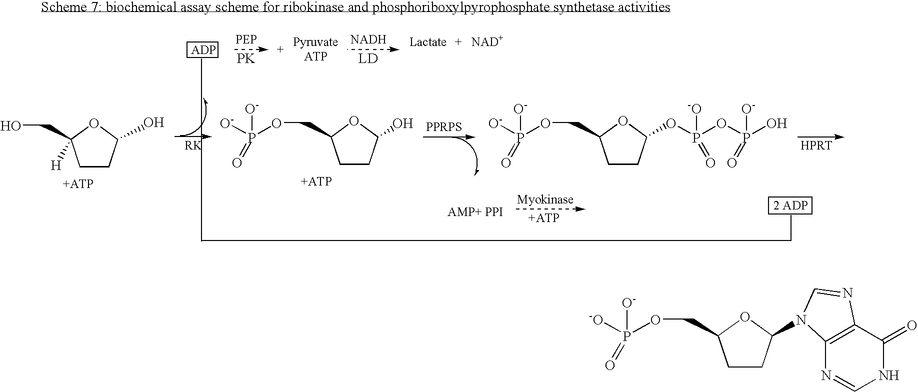

These assays can be relevant subsequent to directed evolution experiments, when biochemical rate constants can be measured in order to evaluate effects if mutation on binding and catalysis

(5) Alternative Enzymes

Alternatives to E. coli HPRT include HPRTases from Bacillus halodurans, Streptomyces avermitilis, Pseudomonas aeruginosa, HGPRTases from H. sapiens, Arabidopsis, Mycobacterium, Leishmania, and E. coli. Likewise, GenBank contains 152 entries for PRPP synthetases, and 612 entries for RK, any of which may constitute alternatives to the E. coli enzymes. As mentioned, a pathway alternative to RK might be phosphopentomutase. For example, B. stearothermophilus TH6-2, catalyzes the intramolecular transfer of phosphate in deoxyribose and dideoxyribose. Another alternative can be to employ deoxyribokinase (Tourneux, L., et al., 2000. Genetic and biochemical characterization of Salmonella enterica serovar Typhi deoxyribokinase. J. Bacteriol. 182:869-873) as a progenitor enzyme instead of ribokinase.

c) Assemble Genes into a Biosynthetic Gene Locus by Directed Evolution in a Reverse-Stepwise Fashion to Available Starting Materials or Primary Metabolites.

The dideoxyinosine pathway involves the evolution and construction of a three gene “pathway” in E. coli. With a robust assay for the last step in the synthesis, synthetic substrates, and cloned progenitor enzymes in hand, experiments for retro-consecutive optimization of enzyme activities can commence. This comprises three linked directed evolution projects employing a single screen, as shown FIG. 13.

In the bioretrosynthetic schemes disclosed herein, it can be desirable to have a robust, economical and rapid assay for the last biotransformation in the pathway. It can also be desirable to have a method for introducing mutations into the genes of interest and a method for assembling the genes in a “pathway.”

(1) Target Product Assay Development

An axiom of directed evolution is “you get what you screen for,” and a poorly considered screen can result in failure to detect desired catalytic activity for directed evolution experiments. Some characteristics for designing a robust screen (Arnold, F. H., and Geotgiou, G., 2003, Directed Enzyme Evolution, Screening and Selection Methods, vol. 230. Humana Press, Totowa, N.J.) are (1) high throughput and economical to permit the screening of a large and diverse library of variant clones, (2) sensitive enough to detect small differences in activity in what are initially relatively inactive clones, (3) reproducible to reliably detect small improvements in activity, and (4) sensitive to the desired ultimate function. In the target product/last step assay, five alternatives for screening for the formation of nucleoside analogs based on the purine pathway are described. The assays can contain 100 AM of hypoxanthine, therefore a limit of detection of about 1 to about 5% conversion (0.05-0.5 μM) can be desired.

(a) Methods #1: Enzymatic Assay for Dideoxyinosine Formation.

As described above, a micro-titer enzymatic assay for the detection of the ultimate assay via hypoxanthine consumption is discussed. An advantage of this assay is its tiered nature and its high sensitivity. The ability to monitor small changes in hypoxanthine consumption via the fluorescent Amplex reagent, moderate changes using xanthine oxidase, or gross changes, using direct hypoxanthine chomophore, can permit a wide range of assay parameters during directed evolution screening. A possible disadvantage may be that this assay is detecting depletion of a 100 μL solution of 100 μM hypoxanthine. Errors in measurement can originate from hypoxanthine solution pipetting errors, which are reported by Brinkman Instruments to be ±1%/50 μl and ±3%/10 μl for our multi-channel pipettes, and may compromise the ability to detect small differences in activity at early stages of screening. The utility of this assay can be evaluated after the activity of HPRT for ddPPRP is measured. If the activity of ddPPRP, in terms of hypoxanthine consumption, is greater than or equal to about 4% of the reaction of PPRP, this assay can be sufficiently robust for the methods disclosed herein. In the event that this is not the case, several alternative methods disclosed below can be used.

(b) Methods #2: In vivo Assays for Dideoxyinosine Formation

One alternative to the biochemical assay described is in vivo biological assay. These assays can be conducted directly on culture plates or microtiter plates and, due to simplicity and economy, can screen larger numbers of clones. In the context of nucleoside activity in biological systems, nucleoside analogs can be multiply phoshorylated in order to be converted to active drugs in vivo. In the case of ddI, for example, it is aminated and phosphorylated to the active drug ddATP in vivo (Tan, X. L., et al., 1999, Development and optimization of anti-HIV nucleoside analogs and prodrugs: A review of their cellular pharmacology, structure-activity relationships and pharmacokinetics, Adv. Drug Delivery Rev. 39:117-151) (Scheme 8). In Scheme 8, NK is nucleoside phosphate kinase, AS/AL is adenylosuccinate synthase/lyase, and AK is adenosine kinase.

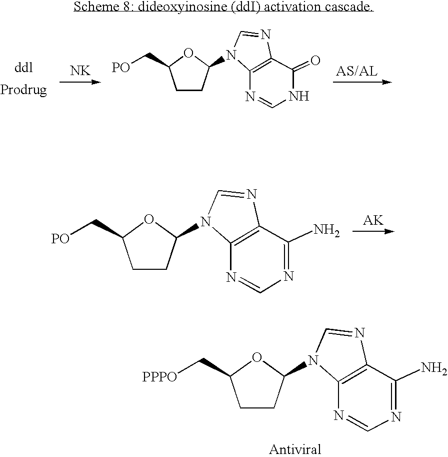

From previous studies, the cited rate limiting step is the first step, phosphorylation of ddI to ddIMP. Since the bioretrosynthetic approach in this example results in the intracellular formation of ddIMP, this slow activation step can be bypassed and it can be predicted that E. coli, or E. coli transformed with adenylate kinase, can be directly sensitive to intracellular ddIMP. Evidence for this can be found in the work of Stemmer et al. (1999, Directed evolution of thymidine kinase for AZT phosphorylation using DNA family shuffling, Nat Biotechnol 17:259-264), in which E. coli are made sensitive to AZT by addition of thimidine kinase on a separate compatible plasmid. Implementation of this screen was turbidometric, via micro-titer plate and was used to evolve the activity of thimidine kinase itself 16,000 fold versus the wild-type enzyme. A similar separate study reports sensitization of E. coli to dideoxy cytosine.

This approach can be validated in E. coli and employed as a screen in evolution of ddI biosynthesis. The method can consist of transforming the mutagenic library into E. coli BL21DE3 and co-administering inducing agent IPTG with ddPPRP. Growth inhibition in 96-well microtiter plates by turbidometric assay can reveal the presence of ddIMP synthesis in vivo. E. coli BL21DE3 can be further sensitized by co-transformation with adenylate kinase on a low copy number plasmid under the control of the lac operon.

(c) Methods #3: HPRT Library Biosynthetic Diversity via Alternate Route

With a diverse library in hand, alternate means of testing the HPRT library catalytic potential can be envisioned. The natural sugar PRPP and an unnatural base, can be useful.

HPRT library can be evolved into a ribavirin monophosphate synthase enzyme using the same library generation techniques as for ddI (see Scheme 9). PRPP is commercially available and the ribavirin base can be obtained by a known two-step synthesis or by hydrolysis of commercial ribavirin. Also, this experiment queries the importance of the 2- and 3-hydroxyls in PPRP and analogs, as well as the tolerance to alternate base analogs. If E. coli HPRT cannot tolerate dideoxy-PRPP for this reason, then alternative progenitor enzymes can be used. Futher, ribavirin monophosphate is a selective inhibitor of cellular inosine monophosphate dehydrogenase (IMPDH), a lynchpin enzyme in the biosynthesis of essential pyrimidine nucleotides. E. coli in which IMPDH has been deleted are incapable of growing in minimal media (Christians, F. C., et al., 1999, Directed evolution of thymidine kinase for AZT phosphorylation using DNA family shuffling, Nat. Biotechnol. 17:259-264; Gilbert, H. J., and Drabble, W. T., 1980. Complementation In vitro between Guab Mutants of Escherichia-Coli-K12. J. General Microbiol. 117:33-45). Ribavirin monophosphate is a competitive inhibitor of IMPDH and its intracellular biosynthesis can be lethal to E coli. This forms the basis of a ready-made survival based bioassay for ribavirin production by our mutant library.

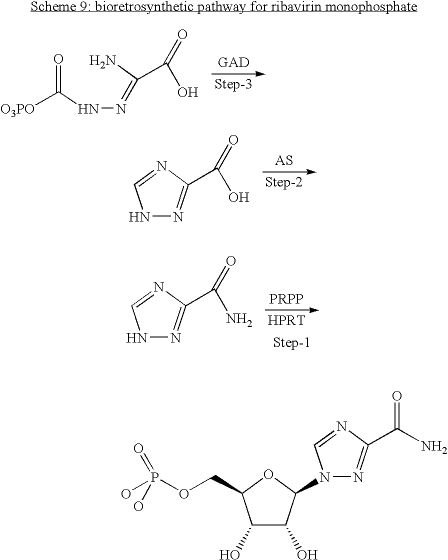

The assay for this pathway can be inosinemonophosphate dehydrogenase inhibition in vivo. IMPDH determines the growth rate for E. coli in M9 medium.

(d) Methods #4: Mass Spectral Assays for Dideoxyinosine

A suitable assay for biosynthesis is direct detection of metabolite of interest. Advances in mass spectrometry have made this assay possible. Optimized pharmacokinetic protocols for detection of ddA triphosphate have already been developed with a limit of quantitation in whole cells of 0.02 ng/mL. This is well below the sensitivity requirements of the assays used in the disclosed methods. In a separate study, LC/MS/MS methods are described for detecting femptomoles of ddA, ddATP, and d4T-TP. In both cases, internal standards permit full validation of these routine methods.

Some advantages of mass spectrometric approaches are the sensitivity and the ability to simultaneously detect multiple ions in a single sample. An alternative approach can use MALDI mass spectrometry to process samples more rapidly in a more high through-put method. Cell-free extracts can be aliquoted to MALDI targets with matrix and evaporated. Assay time and therefore cost can be decreased.

(e) Methods #5: Immunological Assays for ddIMP

Another option for high-throughput ddIMP detection is the development of sensitive and specific antibodies. A recent study (Le Saint, C., et al., 2004. Determination of ddATP levels in human immunodeficiency virus-infected patients treated with dideoxyinosine. Antimicrobial Agents Chemother. 48:589-595) describes a highly sensitive assay based on antibodies raised to ddATP-citrate. Sensitivities of about 1.5×10⁻¹¹ are reported for detection ddATP in serum. The same antibody detects ddI with a sensitivity of 1.5×10⁻⁸ M, corresponding to 0.015 μM. This literature method is well within the target sensitivity rage needed in the disclosed methods.

(2) Directed Evolution Library Generation

There are many means of introducing sequence diversity in gene libraries, and such methods have become routine in molecular biology. The primary goal of these experiments is to produce a large and diverse library of mutants that captures a portion of structure-activity space for target biocatalytic enzymes. Some practical considerations are the number of mutations per gene and the number of transformants per ligation. One or more of the following methods can be used in a given study.

(a) Methods #1: Error Prone PCR

One method of introducing mutations into a given gene is mutagenic PCR. In this method, the native error rate of Taq DNA polymerase is enhanced by including higher concentrations of MgCl₂ and/or MnCl₂ in order to stabilize non-complementary pairing. Alternately, varying nucleotide triphosphate concentrations can achieve mutation frequencies of about 0.11 to about 2%. HPRT can be mutated via mutagenic PCR. Recently, commercially available systems have become available that allow highly random and tunable error-prone PCR (STRAGENES MUTAZYME™ System). Correspondingly, primers can be designed to amplify HPRT from previously cloned pET28-HPRT vector at least 20 base pairs from the engineered restriction sites. This can increase subsequent digestion and ligation efficiency and ultimately improve transformation efficiencies. Mutation rates can be determined by sequencing from about 5 to about 10 clones and averaging the mutation rates. Since HPRT is a small gene (approximately 500 bp), a relatively high mutation rate of from about 0.2 to about 0.4% can introduce desired one to two mutations per gene.

An example of an application of error prone PCR is found in directed evolution of D-2-keto-3-deoxy-6-phosphogluconate aldolase to accept new substrate variants. With a pool of only 1000 clones, a 70-fold improvement of aldolase activity was achieved. As this gene is approximately the same size as HPRT, initial PCR conditions for mutagenesis can be based on this study. Mutagenic PCR can be carried out on HPRT and PCR products can be ligated into pET28a using flanking restriction sites introduced by PCR primers.

In the first round of mutagenesis, about 1000 clones can be selected for screening via hypoxanthine consumption assay. Promising clones can be re-tested for improved activity by Vₘₐₓ/Kₘ measurements versus wild-type under standard conditions. Clones with confirmed improved activity can be subjected to future rounds of mutation and selections. Due to biases in inherent polymerase base mutation frequencies, parameters and additives can be arrayed to maximize library diversity.

(b) Methods #2: DNA Shuffling and Family Shuffling

DNA shuffling is a method for in vitro recombination of genes with high sequence similarity. Parent sequences with >65% similarity can be digested with DNAseI and purified from an agarose gel. These fragments can then be reassembled by polymerase and amplified with primers to generate full-length chimeras. Protocols and methods are described extensively in literature (Schmidt, D. M., et al., 2003. Evolutionary potential of (beta/alpha)8-barrels: functional promiscuity produced by single substitutions in the enolase superfamily. Biochem. 42:8387-8393). This method can be used after improved clones are isolated in order to isolate beneficial combinations of mutations from the parent clones. This method was used effectively in the evolution of thimidine kinase to accept AZT with 16,000 fold improved activity. DNA shuffling methodology is frequently applied to sequences obtained by mutagenic PCR or close sequence relatives.

(c) Methods # 3: Saturation Mutagenesis

Another method of diversifying a gene library is via saturation mutagenesis, either for an entire protein or for a region of interest. In the case of an entire protein, systematic mutagenesis of every codon in a gene sequence can scan for regions which may be candidates for substitution. In the case of saturation mutagenesis of a region of interest a “hot spot” is carefully selected for which it is hypothesized that alterations may beneficially affect catalytic activity. If the X-ray structure is known, residues in the active site binding region can be selected an mutated to the various proteogenic amino acids.

(d) Methods #4: Ligation and Transformation of Library

Subsequent to in vitro techniques of introducing mutations, gene constructs can be assembled for gene expression of the mutant library. This is frequently accomplished by ligation of restricted PCR product and dephosphorylated vector with DNA ligase. Gene constructs can then be transformed into cells capable of promoting overexpression. For the pET based vectors in this proposal, this organism can contain the T7 RNA polymerase gene, which is usually introduced into a given organism as a λDE3 lysogen. Several λDE3 lysogenic strains are commercially available, and E. coli BL21(DE3), a common expression host, has been employed for expression of mutant libraries. Thousands of transformants are needed in order to generate populations sufficient for screening for a desired chemistry. Thus, a consideration in library creation is the transformation efficiency of the ligation reaction, which is usually at least 100-fold less efficient than that of purified plasmid DNA. One of two strategies for library creation can be envisioned, direct transformation and relay library transformation. In both cases, the ligation reaction consists of appropriately digested Arctic phosphatase dephosphorylated vector and an excess of digested PCR product.

Direct transformation comprises transforming electrocompetent BL21(DE3) cells (specially washed log phase cells), with the ligation reaction mixture. Parameters for optimizing transformation efficiency include the ratio of vector to insert, the concentration of DNA, and the electroporation parameters and volume. Mutation frequency can be calculated by direct sequencing of several clones.

Relay transformation comprises transforming the ligation into a high transformation efficiency host. For example, Electromax DH10β cells reporting an efficiency of 1×10¹⁰ cfu/μg versus chemically competent BL21DE3, reporting an efficiency of 1×10⁶ cfu/μg. Plasmid DNA from a sub confluent library of DH10β on selective agar is then used to transform chemically competent BL21DE3. Care should be taken to assure the diversity of the library by direct sequencing several clones. An example of relay transformation is given above.

(3) Evaluation of Library

Whatever method is used to generate gene diversity, the quality of the library can be evaluated with appropriate positive controls. The mutation rate can be estimated under the selected PCR/shuffling conditions by direct sequencing of several clones in the expression system organism. From about 5 to 10 clones can be sequenced using primers specific for pET/pACYC inserts. The library can then be evaluated by activity profiles of a small (approximately 96 clone) population compared to an equal population of parent clones. A library with about 30% of mutants having less than 10% parent activity is suitable. The standard deviation of the parent library should be sufficiently small to detect improvements in the mutant libraries. For example, if a two-fold improvement in activity was detected, a standard deviation of about 15% would be suitable (Salazar, S. A., and Sun, L., 2003. Evaluating a Screen and Analysis of Mutant Libraries. Methods Mol. Biol. 230:85-100).

(4) Retro Assembly of Pathway and Directed Evolution

After optimization of the last step in the pathway (e.g., HPRT activity in Example 1 or E-F in FIG. 1), the next to the last step (e.g., PPRPS activity in Example 1 or D-E in FIG. 1), can be optimized by directed evolution of PPRPS with optimized HPRT coexpressed as a reporter. RK can be co-overexpressed in the presence of the other two. Co-expression of selected genes can be accomplished by use of Duet system vectors (Novagen, San Diego, Calif.), which comprises a series of vectors with compatible origins of replication, multiple cloning sites and antibiotic resistance markers. Up to 8 genes can be simultaneously co-expressed using DUET vectors.

1) The ET28-HPRT library can be transformed into E. coli BL21(DE3).

2) The pACYC-PPRPS mutant library can be transformed into best pET28-HPRT clone. The best pACYC-PPRPS clone can be selected for the next step.

3) The pACYC-PPRPS-RK library can be transformed into best pET28-HPRT clone.

(a) Methods #1: System for Overexpression of Three Genes

Two vectors for the bioretrosynthetic assembly of dideoxyinosine in E. coli: pET28a and pACYCD (Novagen Inc) can be constructed. The pET28a vector uses a kanamycin resistance marker and the ColE1 replicon which has a copy number of approximately 40. The pACYCD uses a chloramphenicol selectable marker and P15 replicon which results in a copy number of approximately 12. pACYCD also has two distinct multiple cloning sites into which PCR products can be directionally cloned. This strategy has been reported to be successful for stable maintenance of both plasmids, as is disclosed herein for simultaneous active expression of HPRT and PPRPS. The higher copy number of peET28a-HPRT can be desirable for the ddI pathway. Increasing the flux of the last step in the biosynthesis can help drive the pathway equilibrium population to favor product formation.

The biochemical requirements of each enzyme can be noted, and conditions compatible to tandem transformation can be selected and tested. For instance, typical conditions for HPRT catalysis are hypoxanthine (100 μM), PPRP (1 mM), MgCl₂ (12 mM), and Tris (100 mM pH=7) (Munagala, N. R., et al., 1998. Steady-state kinetics of the hypoxanthine-guanine-xanthine phosphoribosyltransferase from Tritrichomonas foetus: the role of threonine-47. Biochem. 37:4045-4051). Typical conditions for PPRP synthetase catalysis are ATP (2 mM), ribose-5-phosphate (1 mM) MgCl₂ (5 mM), triethanolamine (50 mM, pH=8), and notably phosphate (10 mM) (Willemoes, M., et al., 2000. Steady state kinetic model for the binding of substrates and allosteric effecters to Escherichia coli phosphoribosyl-diphosphate synthase. J. Biol. Chem. 275:35408-35412). Ribokinase is optimally active in the presence of potassium ions (5 mM KCl) (Andersson, C. E., and Mowbray, S. L., 2002. Activation of ribokinase by monovalent cations. J. Mol. Biol. 315:409-419).

(5) Characterization of Mutant Enzymes

As the pathway is assembled, analysis of structural changes and their effect on binding and catalysis can provide insight into evolution of natural product biosynthesis. Most enzymes in the disclosed examples are primary metabolic enzymes involved in nucleoside biosynthesis, of course other primary metabolic enzymes involved the biosynthesis of other natural products can be used, depending on the target molecule. In the context of nucleosides, which are fundamental constituents of DNA in all living systems, there is considerable interest in the mechanism of these enzymes and their tolerance or lack of tolerance to alternate substrates. HPRT is a drug target for protozoan parasites like Trypanosoma cruzi, which lack the enzymes required for de novo purine synthesis of nucleosides and are dependent upon HPRT. The effect of mutations on binding and catalysis can be deconvoluted by classical steady-state kinetic analysis of enzyme candidates. Insights into structural factors can be obtained by homology modeling and X-ray structure.

(a) Methods #1: Kinetics

Steady state kinetics can be measure for each evolved enzyme in the disclosed methods. Data can be fit to the appropriate mechanism (sequential, ordered, etc.) and kinetic constants can be obtained. Sources of rate enhancement that can be untangled include, but are not limited to, a) improved expression levels, for instance, due to codon optimization, b) improved binding of substrate analog [Kₘ], c) improved rate of substrate analog [k_{cat}], d) relaxed substrate specificity. Also, these data can be used to estimate metabolic flux in the evolved pathways, and be compared to “wild-type” reconstructed system. In a metabolic network, it may not be the case that optimum overall pathway turnover is predicated on maximal individual enzyme turnover. Assay conditions and rate equations can be adapted from previously reported studies of wild-type enzymes as described herein.

(b) Methods #2: Structural Analysis by Homology Modeling

All enzymes in disclosed examples have been characterized by X-ray crystallography. Initially, analysis of the structural changes in evolved enzymes can be accomplished by mapping mutations to the X-ray structures of the parent enzymes. Further insight into substrate binding and catalysis can be obtained through new X-ray structural studies. Synthetic substrates can be co-crystallized with wild-type enzymes and evolved enzymes in order to gain more insight into the structural ramifications of mutations.

(6) Alternative Enzymes

One example of a non-dideoxyinosine pathway evolution utilizing the same substrates and enzymes as HPRT was provided by the ribavirin study disclosed herein. Other pathways that can directly use methods and materials provided herein, include pathways from pyrimidine salvage and upstream nucleotide modifications. As shown in Scheme 10, pyrimidine salvage enzymes, such as uracil pyrophosphoryl transferase from Bacillus caldyolyticus, (Ghim, S. Y., and Neuhard, J., 1994. The pyrimidine biosynthesis operon of the thermophile Bacillus caldolyticus includes genes for uracil phosphoribosyltransferase and uracil permease. J. Bacteriol. 176:3698-707; Ghim, S. Y., et al., 1994. Molecular characterization of pyrimidine biosynthesis genes from the thermophile Bacillus caldolyticus. Microbiol. 140 (Pt 3):479-91) have been shown to be efficient catalysts for the production of uridine monophosphate, a key intermediate in the production of pyrimidines.

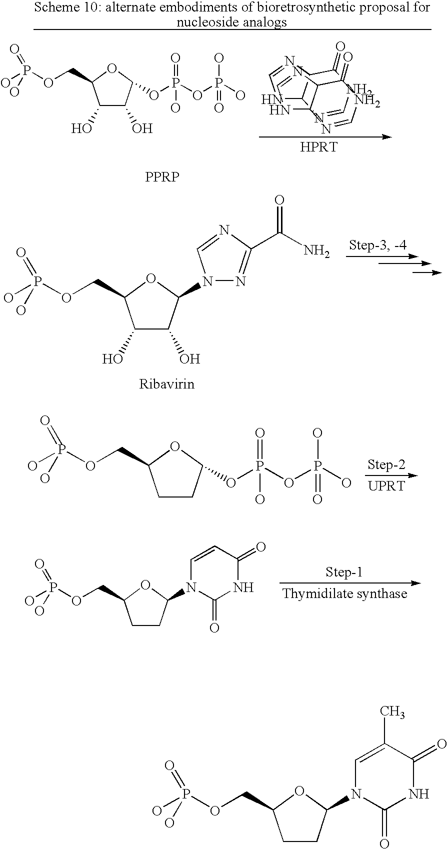

It should also be noted that a wide variety of parental enzymes for nucleoside biosynthesis are characterized and sequenced. E. coli HPRT synthase was chosen as an illustrative example, but there are many more H(X)PRT, PPRPS, and RK enzymes, with varying substrate specificities from varying host organisms, to turn to in case of complications with basal activities. For example, 2-deoxyribokinase and phosphopentomutase have demonstrated competence with dideoxy riboses.

### 3. Example 3

A proposed bioretrosynthetic scheme for the production of dideoxyinosine in E. coli is shown in FIG. 16. The purine salvage enzyme purine nucleoside phoshporylase (PNP) can be recruited first and evolved to convert dideoxyribose-1-phosphate (ddR-1-P) to dideoxyinosine (ddI). Due to instability of synthetic ddR-1-P 3, the evolution of the reverse activity (phosphorylation of ddI and release of hypoxanthine) can be selected for. Subsequently the enzyme phosphopentomutase, can be recruited and evolved to synthesize dideoxyribose-1-phosphate, the penultimate intermediate in the pathway. This gene can be evolved in the presence of previously optimized PNP and a product-based or terminal activity assay can be used to detect turnover. Finally, the process can be iterated with the evolution of ribokinase (RK) to phosphorylate dideoxyribose (ddR, 1) to dideoxyribose-5-phosphate (ddR-5P 2), in the presence of PPM and PNP. At this point a three step pathway for converting dideoxyribose to dideoxinosine phosphate can have been generated. To reiterate, the advantage of retroconsecutive assembly is that only a single sensitive assay is needed to evolve all three enzymes in the pathway.

### 4. Example 4

One example of a non-nucleoside biosynthetic pathway is shown in FIG. 17. In this scheme, a module of a non-ribosomal peptide synthetase is cloned and the condensation domains (C) is evolved to catalyze the condensation of the co-enzyme a functional precursor to praline resulting in enalpril (Step—1). In step—2, a co-enzyme-A ligase, which catlyzes the thiolation of carboxyethylphenhylalanine to the co-enzyme A thioster is evolved (for instance coumeryl CoA ligase). In step—3, opine dehydrogenase is evolved to convert homophenylalanine to the opine, carboxyethylphenylalanine. The natural substrate for this transformation is phenylalanine. The resulting pathway can convert homophenylalanine to the angiotensin converting enzyme inhibitor enalpril, which provides a convenient an inexpensive bioassay for evolution experiments. (Yamato, M.; Koguchi, T.; Okachi, R.; Yamada, K.; Nakayama, K.; Kase, H.; Karasawa, A.; Shuto, K. J Antibiot (Tokyo) 1986, 39, 44-52.)

### 5. Example 5

An example of a mixed polyketide/polypeptide bioretrosynthesis is shown in FIG. 18. In this scheme a polyketide synthase module is evolved to accept a pantathienylated substrate (Step—1). This polyketide synthase module is designed to homologate the peptide with an acetate, reduce the peptide, and hydrolyze it from the megasynthase as shown. Steps—2 to —4 consist of retroconscutive concatenation/evolution of non-ribosomal peptide modules which activate cognate amino acids via adenylation and transthioesterification to be condensed to the peptide chain. The resulting pathway can biosynthesize the hemiasterlin analog shown boxed.

### 6. Example 6

A shorter pathway, in which an unnatural base is incorporated, rather than an unnatural sugar, is shown in FIG. 19. In this pathway, an in vivo assay is used to select for the evolution of HPRT to synthesize ribavirin monophosphate. The next retroconsecutive step recruits asparagine synthetase to convert triazole carboxylate 7 to the carboxamide 6. This experiment provides an example of how a clinically relevant enzyme activity can be used to evolve a biosynthetic pathway.

It is widely appreciated that ribavirin is a broad-spectrum antiviral nucleoside analog. However, ribavirin-1-phosphate 5 has also been demonstrated to be a potent competitive inhibitor of inosine monophosphate dehydrogenase (IMPDH), a lynchpin enzyme in guanosine biosynthesis, and an attractive drug target for the control of parasitic infections. Since it had previously been demonstrated that in the absence of environmental guanosine IMPDH deficient bacteria are unable to replicate, it was hypothesized herein that intracellular biosynthesis of ribavirin-1-phosphate would be lethal to E. coli. This would form the basis of a ready-made survival based bioassay for ribavirin-1-phosphate biosynthesis directed evolution (FIG. 20). In this selection scheme an E. coli library containing variants of the purine salvage enzyme hypoxanthine phosphoribosyltransferase (HPRT) is replicated into M9 media supplemented with 1,2,4-triazole carboxamide 7 “protoxin.” Active enzymes react triazole with endogenous PRPP 8 to form ribavirin monophosphate 5, an IMPDH poison resulting in growth inhibition. Negative controls with synthetically prepared 1,2,4-triazole carboxamide 7 and complementation experiments with guanosine monophosphate confirmed the validity of this method. Subsequently, a library of mutagenized HPRT in E. coli was evaluated. The assay can be improved by adding nutrients to the medium. Amino acids and other nucleotides can be systematically added to mutant and wild-type HPRT clones to demonstrate a more rapid assay for selective IMPDH inhibition.

a) Cloning of Biosynthetic Genes

All proposed progenitor biosynthetic genes, HPRT, PPRPS, and RK, PNP, and AS-B were amplified from purified DH5α E. coli genomic DNA with flanking restriction sites by PCR, and initially cloned into cloning TOPO 2.1 (Invitrogen) cloning vectors, by topoisomerase mediated cloning of the PCR products. To date, HPRT and PPRPS PCR products have been subsequently digested and cloned into pET28a, an IPTG inducible T7-based expression system under the control of the lac operator. Gene sequences have been cloned into restriction sites in pET28a so that they are in-frame with an N-terminal His-tag sequence in order to facilitate purification. Expression of proteins was assayed by SDS-PAGE electrophoresis.

b) Synthesis of Required Biosynthetic Intermediates

Proposed biosynthetic intermediates must be obtained prior to retro-evolution experiments. Scheme 11 shows the synthetic route used to obtain these intermediates. Commercially available lactone (6) was phosphorylated with diisopropylamino dibenzyl phosphoramidite. The lactone was selectively reduced with DIBAL-H resulting in lactol (7). Lactone (6) was directly reduced with DIBAL-H without protection. 1,2,4-triazole carboxamide and 1,2,4-triazole carboxylate were obtained by aminolysis and saponification, respectively, of commercial available methyl ester. All compounds have been characterized by ¹H and ¹³C NMR, ³¹P NMR (when necessary) and high resolution (FAB) mass spectrometry.

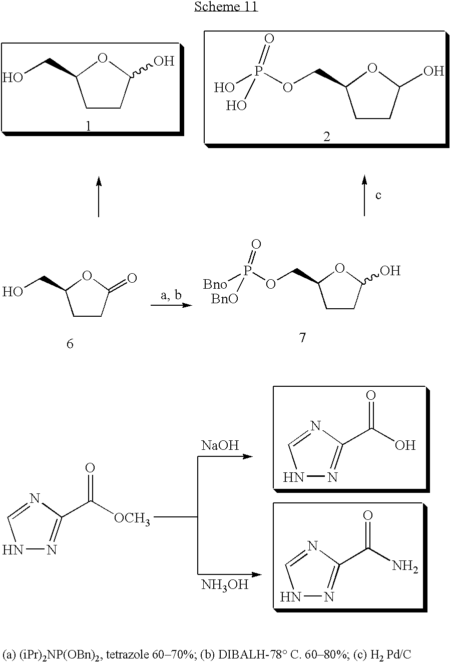

c) Basal Activity of Progenitor Enzymes

An issue to consider before embarking on directed evolution experiments is whether or not a progenitor enzyme has activity that can be improved upon. A useful property in this regard is some detectable basal activity. There is substantial literature precedent for most of the enzymes in the disclosed pathways. For instance, phosphopentomutase and ribokinase have been shown to process deoxy-, and dideoxy-nucleosides, and asparagine synthetase, and homologs, have been demonstrated to amidate β-carboxyacids. In the cases for which no literature precedent exists, basal activity can be demonstrated experimentally. FIG. 21 shows a Lineweaver-Burke plot of relative activities of inosine and dideoxy inosine with PNP. The reverse reaction was monitored using the colorimetric shown in FIG. 7. PNP was capable of phosphorylating ddI, though the Kₘ of ddI (Kₘ₍ₐₚₚ₎=6800 μM) was >100 times that of inosine (Kₘ₍ₐₚₚ₎=56 μM). Similarly, the fitness of HPRT has been demonstrated herein for the acceptance of modified bases. Therefore, all enzymes in the disclosed envisioned schemes demonstrate basal activity from which to evolve improved activities and concatenate pathways.

d) Directed Evolution of Ribavirin Synthase by Error-Prone PCR

HPRT was amplified from E. coli DH5α genomic DNA with flanking restriction sites and cloned into pET28a vector, which was used as a template for the error-prone PCR amplification using the MUTAZYME™ polymerase (Statagene, La Jolla, Calif.). The error rate was optimized for HPRT by varying template concentration and we were able to achieve a mutation rate of ˜4/kilobase. Error-prone PCR product was digested, sub cloned into pET28a, and transformed into E. coli BL21(DE3) by electroporation. Recombinant HPRT contains a, 6×His tag for subsequent affinity purification. The resulting mutant library was picked into master 96-well plates containing LB medium and kanamycin.

A small mutant library of ca. 1000 members was replica plated into 96-well plates containing minimal medium (M9), kanamycin and 200 μM synthetically prepared 1,2,4-triazole carboxamide (2), a concentration found to be non-lethal to transformed E. coli BL21(DE3) under these conditions. Plates were grown for 5 days at 37° C. and cell growth was visualized by staining with tetrazolium blue. Several wells with no growth, or substantially reduced growth were re-grown from the master plate. As shown in FIG. 22A, time course sensitivity determination by triazole dilution assay confirmed that mutants were >2 fold more susceptible to triazole in vivo. The mutant and wild type HPRT enzymes were expressed as His×6 tagged proteins and purified to homogeneity (FIG. 22B).

e) Analysis of Mutations in HPRT Evolved to Process 1,2,4-triazole Carboxamide

All three growth-impaired clones were analyzed by DNA sequencing of isolated plasmids and were demonstrated to code for full-length translated mutants (FIG. 23). Surprisingly, one mutant 8B3 contained five codon changes, three silent and two amino acid substitutions, V153A and Y170H, the former of which is present in the hypoxanthine binding fold. It is also interesting to note that the active site seems to be expanded for a substrate (triazole) that is substantially smaller than the natural substrate (hypoxanthine). This enzyme was selected for further characterization by determination of apparent rate constants for natural and unnatural substrates.

f) Sensitive Kinetic Method Developed for Nucleoside Monophosphate

The kinetic analysis of triazole transferase activity provided a unique analytical challenge for non-natural substrates as changes in UV/Fluoresence absorbance is negligible in these systems. An analytical method for RMP synthesis was developed. In this assay, a reaction containing 1,2,4-triazole, PRPP and HPRT is quenched by passing the reaction through a 1 cc SAX (Phenomenex. Inc., 0.1 g) anion exchange cartridge. Negatively charged ribavirin monophosphate (RMP) and PRPP are bound and other reactants flow through. RMP is eluted with 0.5 M Na₂HPO₄, and since it is the only UV active negatively charged compound, is uniquely detectable by UV measurements. This method has been validated with HPRT by monitoring the time dependent formation of IMP from PPRP and hypoxanthine (FIG. 24). Negative control experiments demonstrate that free triazole and hypoxanthine do not bind to SAX column and positive control experiments with IMP dilutions verify excellent (>95%) recovery of IMP from cell-free extracts. With this kinetic method and purified proteins, apparent rate constants for hypoxanthine, guanine, and triazole for both wild-type and evolved mutant enzymes can be determined.

In the event of difficulties with evolving AS-B as the penultimate progenitor enzyme, an alternative enzyme family is the nitrile hydratase family. This family has been demonstrated to promiscuously hydrolyze organic nitrile groups attached to an aromatic or hetroaromatic rings including benzonitrile and thienonitrile and furonitrile, as well as a number of pyridyl substituted compounds. The synthesis of triazole nitrile is previously reported.

### 7. Example 7

In a separate study, PPRPS was subcloned into the DUET™ vector pACYC vector, which is compatible for co-overexpression with pET28a. pACYC has a unique origin of replication and antibiotic resistance marker that facilitate co-overexpression. pET28-HPRT and PPRPS-pACYC were transformed into chemically competent BL21DE3, which is optimized for IPTG induced overexpression of both vectors. HPRT and PPRPS co-overexpression was verified by SDS-PAGE gel electrophoresis, and tandem enzymatic activity was confirmed (FIG. 25). Though the majority of PRPPS was observed as insoluble protein, a substantial amount of protein was soluble. This was confirmed by nickel affinity (Ni—NTA) purification of soluble His-tagged PPRPS (data not shown), and activity assays (FIG. 26) from HPRT PRPPS-pACYC transformants. These data demonstrate that the in vitro hypoxanthine assay is sufficiently sensitive to report activity of a penultimate step in the pathway.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of producing a target molecule comprising:
a) incubating a precursor A with a selected population of cells, wherein the population of cells comprises a library of expressible genes;
b) identifying cells that produce the target molecule;
c) isolating the gene, calling it gene A, in the cell producing the target molecule;
d) inserting the gene A into a secondary population of cells with a secondary library of expressible products, such that gene A and the library are both expressed;
e) incubating the secondary population of cells from step d) with a precursor B;
f) identifying cells that produces the target molecule and repeating.

2. The method of claim 1, wherein the target molecule is a nucleoside or analog thereof.

3. The method of claim 1, wherein the target molecule is ribavirin or ribavirin monophosphate.

4. The method of claim 1, wherein the target molecule is dideoxyinosine or dideoxyinosine monophosphate.

5. The method of claim 1, wherein the target molecule is a non-ribosomally encoded peptide.

6. The method of claim 1, wherein the target molecule is a polyketide.

7. The method of claim 1, wherein the target molecule is a mixed peptide-ketide.

8. The method of claim 1, wherein the target molecule is an alkaloid.

9. The method of claim 1, wherein the target molecule is a mixed biosynthesis product.


SEQUENCE LISTING (6 sequences)

SEQ ID NO: 1 - DNA, 31 bp, Artificial Sequence
  Description of Artificial Sequence; note = synthetic construct
gaattccatatgatgaaacatactgtagaag

SEQ ID NO: 2 - DNA, 31 bp, Artificial Sequence
  Description of Artificial Sequence; note = synthetic construct
gaattcaagcttttactcgtccagcagaatc

SEQ ID NO: 3 - DNA, 28 bp, Artificial Sequence
  Description of Artificial Sequence; note = synthetic construct
gaattccatatggtgcctgatatgaagc

SEQ ID NO: 4 - DNA, 28 bp, Artificial Sequence
  Description of Artificial Sequence; note = synthetic construct
gaattcctcgagttagtgttcgaacatg

SEQ ID NO: 5 - DNA, 27 bp, Artificial Sequence
  Description of Artificial Sequence; note = synthetic construct
gaattcggatccatgcaaaacgcaggc

SEQ ID NO: 6 - DNA, 28 bp, Artificial Sequence
  Description of Artificial Sequence; note = synthetic construct
gaattcgtcgactcacctctgcctgtct